(19) United States
(12) Patent Application Publication
(10) Pub. No.: US 2024/0235774 A1
(43) Pub. Date: Jul. 11, 2024

(54) REFERENCE SIGNAL FOR FAST SCELL ACTIVATION

(71) Applicant: Telefonaktiebolaget LM Ericsson (publ), Stockholm (SE)

(72) Inventors: Ajit NIMBALKER, Dublin, CA (US); Ravikiran NORY, San Jose, CA (US); Zhenhua ZOU, Solna (SE); Siva MURUGANATHAN, Stittsville (CA)

(21) Appl. No.: 18/560,162

(22) PCT Filed: May 11, 2022
(86) PCT No.: PCT/EP2022/062823

§ 371 Date: Nov. 10, 2023

Related U.S. Application Data
(60) Provisional application No. 63/187,184, filed on May 11, 2021.

(51) Int. Cl. H04L 5/00; H04B 7/06; H04W 76/20

(52) U.S. Cl. CPC H04L 5/0051; H04B 7/0626; H04W 76/20

(57) ABSTRACT

A first network node is disclosed. The first network node is configured to communicate with a wireless device (WD) and includes processing circuitry and a radio interface in communication with the processing circuitry. The processing circuitry is configured to determine a reference signal presence message including presence information of at least one reference signal for an activation of at least one secondary cell. The presence information includes at least one index indicating a trigger state from a trigger state list. The radio interface is configured to transmit the reference signal presence message and receive a report from the WD indicating that the activation of at least one secondary cell using the at least one reference signal is complete. Methods, systems and other apparatuses are disclosed.

### TECHNICAL FIELD

The present disclosure relates to wireless communications, and in particular, to reference signals for activation of cells, such as secondary cells.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

### Carrier Aggregation

Carrier Aggregation (CA) is generally used in NR (5G) and LTE systems to improve WD transmit receive data rate. With carrier aggregation, the WD typically operates initially on single serving cell called a Primary Cell (PCell). The PCell is operated on a component carrier in a frequency band. The WD is then configured by the network with one or more secondary serving cells (SCell(s)). Each SCell can correspond to a Component Carrier (CC) in the same frequency band (i.e., intra-band CA) or different frequency band (i.e., inter-band CA) from the frequency band of the CC corresponding to the PCell. For the WD to transmit and/or receive data on the SCell(s), the SCell(s) need to be activated by a network node. For example, the WD may receive data on the SCell(s) by receiving Downlink Shared Channel (DL-SCH) information on a Physical Downlink Shared Data Channel (PDSCH) or may transmit data by transmitting Uplink Shared Channel (UL-SCH) on a Physical Uplink Shared Data Channel (PUSCH). The SCell(s) can also be deactivated and later reactivated as needed via activation/deactivation signaling via Medium Access Control (MAC) Control Element (CE) or using Radio Resource Control (RRC) signaling.

Typically, a SCell activation procedure can take anywhere between a minimum activation delay (e.g., a few milliseconds) to up to multiple of a 10^{th} or a 100^{th} of milliseconds. Upon reception of an SCell activation command, e.g., via a MAC CE, a WD starts the activation procedure for the corresponding SCell. The activation delay includes a component related to a delay to first Synchronization Signal Block (SSB) delay after a slot in which an Acknowledgement (ACK) is transmitted responsive to reception of activation command MAC CE. The activation procedure is assumed to be complete, i.e., the SCell is considered activated, when the WD sends a valid CSI report for the SCell or a maximum allowed SCell activation delay is reached. The WD is expected to complete the activation procedure based on certain minimum requirements which are scenario-dependent and are captured in the 3GPP Radio Access Network 4 (RAN4) specifications Technical Specification (TS) 38.133. FIG. 1 shows an example of a legacy SCell activation process.

FIG. 2 shows an example of another SCell activation process using a temporary reference signal that is currently being considered in 3GPP. In this example process, along with the SCell activation command, the WD is provided with an additional reference signal, which is known as Temporary Reference Signal (TRS), e.g., an Aperiodic TRS (A-TRS). Thus, the WD can immediately utilize the TRS instead of waiting for a first SSB to start the activation procedure, thereby reducing the activation time. The activation process is assumed to be complete, i.e., the SCell is considered activated, when the WD sends a valid Channel State Information (CSI) report for the SCell or the maximum allowed SCell activation delay is reached. The maximum SCell activation delay may be smaller when the WD is activating using TRS as compared to activating without TRS. FIG. 2 also shows the WD receiving a Channel State Information Reference Signal (CSI-RS) on the SCell being activated, for which the WD measures and transmits a valid CSI report. Consequently, the SCell is considered activated.

A TRS is typically a Non-Zero Power CSI-RS (NZP CSI-RS), which includes a higher layer configuration that includes a ‘trs-Info’ field. The reference signal is typically used by the WDs for time-frequency tracking and Automatic Gain Control (AGC) for receiving DL physical channel or physical signal transmissions. The WDs do not typically send any measurement reports, e.g., Channel Quality Indicator (CQI), Precoding Matrix Indicator (PMI), Rank Indicator (RI), Reference Signal Received Power), in response to receiving TRS. When trs-Info field is indicated for a NZP-CSI-RS-ResourceSet (e.g., included in an RRC configuration), the WD can determine information about the antenna port, e.g., when the antenna port has the same port index as the configured NZP CSI-RS resources in the NZP-CSI-RS-ResourceSet. (e.g., as described in 3GPP TS 38.214, clause 5.1.6.1.1). TRS may also be known as CSI-RS for tracking or CSI RS to tracking RS.

For a NZP-CSI-RS-ResourceSet configured with the higher layer parameter trs-Info, the WD shall assume the antenna port with the same port index of the configured NZP CSI-RS resources in the NZP-CSI-RS-ResourceSet is the same.

For Frequency Range 1 (FR1), the WD may be configured with one or more NZP CSI-RS set(s), where a NZP-CSI-RS-ResourceSet consists of four NZP CSI-RS resources in two consecutive slots with two NZP CSI-RS resources in each slot. If no two consecutive slots are indicated as downlink slots by tdd-UL-DL-ConfigurationCommon or tdd-UL-DL-ConfigDedicated, then the WD may be configured with one or more NZP CSI-RS set(s), where a NZP-CSI-RS-ResourceSet consists of two NZP CSI-RS resources in one slot.

For Frequency Range 2, the WD may be configured with one or more NZP CSI-RS set(s), where a NZP-CSI-RS-ResourceSet consists of two CSI-RS resources in one slot or with a NZP-CSI-RS-ResourceSet of four NZP CSI-RS resources in two consecutive slots with two NZP CSI-RS resources in each slot.

### Transmission Configuration Indication (TCI) States as Defined in NR 3GPP Release 15 and 3GPP Release 16

Several signals can be transmitted from different antenna ports of a same network node, e.g., base station, and these signals can have the same large-scale properties, such as Doppler shift/spread, average delay spread, or average delay. In this case, the antenna ports are said to be Quasi Co-Located (QCL).

If the WD knows (i.e., determines) that two antenna ports are QCL with respect to a certain parameter, e.g., Doppler spread, the WD can estimate the parameter based on one of the antenna ports and apply the estimate for receiving signal on the other antenna port. For example, the TCI state may indicate a QCL relation between a CSI-RS for TRS and the PDSCH Demodulation Reference Signal (DMRS) or a QCL relation between a SSB and a TRS. When the WD receives the TRS, the WD can use the measurements already made on the SSB to assist the TRS reception.

Information about what assumptions can be made regarding QCL is signaled to the WD from a network node. In NR, four types of QCL relations between a transmitted source RS and transmitted target RS were defined:

Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. Generally, if two transmitted antenna ports are spatially QCL, the WD can use the same Rx beam or spatial filter. Using the same Rx beam or spatial filter is helpful for a WD that uses analog beamforming to receive signals, since the WD adjusts its Rx beam in some direction prior to receiving a certain signal. If the WD knows that the signal is spatially QCL with some other signal the WD has received earlier, then the WD can safely use the same Rx beam to receive also the signal. For beam management, discussions mostly revolve around QCL Type D, but conveying a Type A QCL relation for the RSs to the WD may be needed, so that the WD can estimate all the relevant parameters, e.g., large-scale parameters. Typically, this is achieved by configuring the WD with a CSI-RS for TRS for time/frequency offset estimation. To be able to use any QCL reference, the WD would have to receive the QCL reference with a sufficiently good Signal to Noise Ratio (SINR). In many cases, the TRS will have to be transmitted in a suitable beam to a certain WD.

To introduce dynamics in beam and Transmission Point (TRP) selection, the WD can be configured through RRC signaling with M TCI states, where M is up to 128 in FR2 for the purpose of PDSCH reception and up to 8 in FR1, depending on WD capability.

Each TCI state contains QCL information, i.e., one or two source Downlink (DL) RSs, each source RS being associated with a QCL type. For example, a TCI state contains a pair of reference signals, where each reference signal is associated with a QCL type, e.g., two different CSI-RSs {CSI-RS1, CSI-RS2} is configured in the TCI state as {qcl-Type1, qcl-Type2}={Type A, Type D}. Then, the WD can derive Doppler shift, Doppler spread, average delay, delay spread from CSI-RS1 and Spatial Rx parameter (i.e., the RX beam to use) from CSI-RS2.

Each of the M states in the list of TCI states can be interpreted as a list of M possible beams transmitted from a network node or a list of M possible TRPs used by the network node to communicate with the WD. The M TCI states can also be interpreted as a combination of one or multiple beams transmitted from one or multiple TRPs.

A first list of available TCI states can be configured for PDSCH, and another list of TCI states can be configured for PDCCH. Each TCI state contains a pointer, known as TCI State ID, which points to the TCI state. The network then activates via MAC CE one TCI state for PDCCH (i.e., provides a TCI for PDCCH) and up to eight active TCI states for PDSCH. The number of active TCI states the WD supports is a WD capability, but the maximum number is 8. Each configured TCI state contains parameters for the quasi co-location associations between source reference signals, e.g., CSI-RS, Synchronization Signal (SS), Physical Broadcast Channel (PBCH), and target reference signals, e.g., PDSCH/PDCCH DMRS ports. TCI states are also used to convey QCL information for the reception of CSI-RS or TRS.

A WD may configured (e.g., be assumed to be configured) with four active TCI states, e.g., from a list of totally 64 configured TCI states. Hence, 60 TCI states are inactive for this particular WD and the WD does not need be prepared to have large scale parameters estimated. Some states may also be active for another WD. But the WD continuously tracks and updates parameters, e.g., the large-scale parameters, for the 4 active TCI states by measuring and analyzing source RSs indicated by each TCI state. When scheduling a PDSCH to a WD, a DCI contains a pointer to one active TCI. The WD then knows which large-scale parameter estimate to use when performing PDSCH DMRS channel estimation, and, thus, when performing PDSCH demodulation.

For WD-specific PDSCH, one or more of the configured TCI states can be activated via either a MAC CE, e.g., MAC CE described in 3GPP TS 38.321 V16.4.0, Clause 6.1.3.14, or the MAC CE described in 3GPP TS 38.321 V16.4.0, Clause 6.1.3.24. The activated TCI states are mapped to codepoints of a TCI configuration information (TCI) field of a DL (Downlink Control Information (DCI) (e.g., with DCI format 1_1 or 1_2). The network node, e.g., gNB, can then use a DL DCI (with either format 1_1 or 1_2) to indicate to the WD that the WD shall use the activated TCI state(s) indicated by the TCI field of the DL DCI for subsequent PDSCH reception.

### 3GPP Release 17 (Rel-17) NR TCI State Framework

In 3GPP Rel-17, a new TCI state framework will be specified for NR. It is already agreed that the new TCI state framework should include a three stage TCI state indication (i.e., in a similar way as was described above for WD specific PDSCH) for all DL or a subset of all DL and/or UL channels/signals. In the first stage, RRC is used to configure a pool of TCI states. In the second stage, one or more of the RRC configured TCI states are activated via MAC-CE signaling. Finally, in the third stage, DCI signaling is used to select one of the TCI states that was activated via MAC-CE. The TCI states used for DL and UL channels/signals can either be taken from the same pool of TCI states (e.g., joint TCI states) or from separate pools of TCI states (e.g., from separate DL TCI state and UL TCI state pools). Two separate list of activated TCI states may also be used, where one list is for DL channels/signals and the other list is for UL channels/signals.

Once the WD is indicated or updated with the TCI state(s) via the DCI, the WD will use the indicated or updated TCI state(s) for receiving DL and/or UL channels/signals. If the TCI states are joint TCI states, then the joint TCI states are used for receiving DL and UL channels/signals. If the TCI states are separate DL TCI states and UL TCI states, then the DL TCI states are used for receiving DL channels/signals and the UL TCI states are used for receiving UL channels/signals.

A benefit of the Rel-17 TCI state framework is that TCI states or spatial relations do not have to be separately configured/activated/indicated for different DL/UL channels and signals. Hence, the TCI state activation/update latency can be reduced compared to the existing TCI state framework in NR Release 15 and Release16. The use of TCI states described in NR Release 17 (Rel-17) are also referred to as common beam operation where different channels/reference signals are received using the same beam. For this reason, the TCI states introduced in NR Rel-17 are also sometimes known by the terms unified TCI states or common TCI states.

### CSI-RS

A WD configured with NZP-CSI-RS-ResourceSet(s) that is configured with higher layer parameter trs-Info may have the CSI-RS resources configured as:
Periodic, with the CSI-RS resources in the NZP-CSI-RS-ResourceSet that is configured with the same periodicity, bandwidth and subcarrier location
Periodic CSI-RS resource in one set and aperiodic CSI-RS resources in a second set, where the aperiodic CSI-RS and periodic CSI-RS resource have the same bandwidth, e.g., with same Resource Block (RB) location, and the aperiodic CSI-RS being ‘QCL-Type-A’ and ‘QCL-TypeD’, where applicable, with the periodic CSI-RS resources. For FR 2, the WD does not expect that a scheduling offset between the last symbol of a PDCCH carrying a triggering DCI and a first symbol of aperiodic CSI-RS resources to be smaller than a WD reported ThresholdSched-Offset. The WD shall expect that the periodic CSI-RS resource set and aperiodic CSI-RS resource set are configured with the same number of CSI-RS resources and with the same number of CSI-RS resources in a slot. For the aperiodic CSI-RS resource set, if triggered, and if the associated periodic CSI-RS resource set is configured with four periodic CSI-RS resources with two consecutive slots with two periodic CSI-RS resources in each slot, the higher layer parameter aperiodicTriggeringOffset indicates a triggering offset for a first slot for the first two CSI-RS resources in the set.

Typically, a WD does not expect to be configured with a CSI-ReportConfig that is linked to a CSI-ResourceConfig containing an NZP-CSI-RS-ResourceSet configured with trs-Info and with the CSI-ReportConfig configured with the higher layer parameter timeRestrictionForChannelMeasurements set to ‘configured’. A WD does not expect to be configured with a CSI-ReportConfig with a higher layer parameter reportQuantity set to other than ‘none’ for aperiodic NZP CSI-RS resource set configured with trs-Info. Also, a WD does not expect to be configured with a CSI-ReportConfig for periodic NZP CSI-RS resource set configured with trs-Info and does not expect to be configured with a NZP-CSI-RS-ResourceSet configured both with trs-Info and repetition.

Each CSI-RS resource is configured by a higher layer parameter NZP-CSI-RS-Resource with the following restrictions:
Time-domain locations of two CSI-RS resources in a slot, or of four CSI-RS resources in two consecutive slots, which are the same across two consecutive slots, as defined by higher layer parameter CSI-RS-resourceMapping, is given by one of:
   l∈{4,8}, l∈{5,9}, or l∈{6,10} for frequency range 1 and frequency range 2;
   l∈{0,4}, l∈{1,5}, l∈{2,6}, l∈{3,7}, l∈{7,11}, l∈{8,12}, or l∈{9,13} for frequency range 2:
A single port CSI-RS resource with a density ρ=3, such as given by Table 7.4.1.5.3-1 of 3GPP TS 38.211, and a higher layer parameter density configured by CSI-RS-ResourceMapping;
A bandwidth of the CSI-RS resource, as given by higher layer parameter freqBand configured by CSI-RS-ResourceMapping, is the minimum of 52 and N_{BWP,i}^{size} resource blocks, or is equal to N_{BWP,i}^{size} resource blocks. For operation with shared spectrum channel access, freqBand configured by CSI-RS-ResourceMapping, is the minimum of 48 and to N_{BWP,i}^{size} resource blocks, or is equal to N_{BWP,i}^{size} resource blocks;
The WD is not expected to be configured with the periodicity of 2^{μ}×10 slots if the bandwidth of CSI-RS resource is larger than 52 resource blocks;
A periodicity and a slot offset for periodic NZP CSI-RS resources, as given by the higher layer parameter periodicity AndOffset configured by NZP-CSI-RS-Resource, is one of BWP, i 2^{μ}Xₚ slots where Xₚ=10, 20, 40, or 80 and where μ is defined as in TS 38.211, Clause 4.3; and
A same powerControlOffset and a powerControlOffsetSS given by NZP-CSI-RS-Resource value across all resources.

### NZP CSI-RS

A WD can be configured with one or more NZP CSI-RS resource set configuration(s) as indicated by the higher layer parameters CSI-ResourceConfig, and NZP-CSI-RS-ResourceSet. Each NZP CSI-RS resource set consists of K≥1 NZP CSI-RS resource(s).

The following parameters for which the WD shall assume non-zero transmission power for CSI-RS resource are configured via the higher layer parameter NZP-CSI-RS-Resource, CSI-ResourceConfig, and NZP-CSI-RS-ResourceSet for each CSI-RS resource configuration:
nzp-CSI-RS-ResourceId determines CSI-RS resource configuration identity;
periodicity AndOffset defines CSI-RS periodicity and slot offset for periodic/semi-persistent CSI-RS. All the CSI-RS resources within one set are configured with the same periodicity, while the slot offset can be same or different for different CSI-RS resources;
resourceMapping defines the number of ports, Cloud Data Management type (CDM-type), and an Orthogonal Frequency Division Multiplexing (OFDM) symbol and a subcarrier occupancy of a CSI-RS resource within a slot, as described in 3GPP TS 38.211, Clause 7.4.1.5.
nrofPorts in resourceMapping defines a number of CSI-RS ports, where allowable values are given, as described in 3GPP TS 38.211, Clause 7.4.1.5.
A density in resourceMapping defines CSI-RS frequency density of each CSI-RS port per PRB, and a CSI-RS PRB offset in case of the density value of ½, where the allowable values are given as described 3GPP TS 38.211, Clause 7.4.1.5. For density ½, an odd/even PRB allocation indicated in density is with respect to the common resource block grid.
cdm-Type in resourceMapping defines CDM values and pattern, where the allowable values as described in 3GPP TS 38.211, Clause 7.4.1.5.
powerControlOffset, which is an assumed ratio of PDSCH Energy per Resource Element (EPRE) to NZP CSI-RS EPRE when the WD derives CSI feedback and takes values in the range of [−8, 15] dB with 1 dB step size.
powerControlOffsetSS, which is the assumed ratio of NZP CSI-RS EPRE to SS/PBCH block EPRE.
scramblingID defines scrambling ID of CSI-RS with length of 10 bits.
Bandwidth Part Id (BWP-Id) in CSI-ResourceConfig defines which bandwidth part the configured CSI-RS is located in.
A repetition in a NZP-CSI-RS-ResourceSet is associated with a CSI-RS resource set and defines whether the WD can assume the CSI-RS resources within the NZP CSI-RS Resource Set are transmitted with the same downlink spatial domain transmission filter or not as described in 3GPP TS 38.211, Clause 5.1.6.1.2 and can be configured only when the higher layer parameter reportQuantity associated with all the reporting settings linked with the CSI-RS resource set is set to ‘cri-RSRP’, ‘cri-SINR’ or ‘none’.
qcl-InfoPeriodicCSI-RS contains a reference to a TCI-State indicating QCL source RS(s) and QCL type(s). If the TCI-State is configured with a reference to an RS with ‘QCL-TypeD’ association, that RS may be an SS/PBCH block located in the same or a different CC/DL BWP or a CSI-RS resource configured as periodic that is located in the same or different CC/DL BWP.
trs-Info in NZP-CSI-RS-ResourceSet is associated with a CSI-RS resource set and for which the WD can assume that the antenna port with the same port index of the configured NZP CSI-RS resources in the NZP-CSI-RS-ResourceSet is the same, as described in 3GPP TS 38.211, Clause 5.1.6.1.1 and can be configured when reporting setting is not configured or when the higher layer parameter reportQuantity associated with all the reporting settings linked with the CSI-RS resource set is set to ‘none’.

All CSI-RS resources within one set are configured with same density and same nrofPorts, except for the NZP CSI-RS resources used for interference measurement. The WD expects that all the CSI-RS resources of a resource set are configured with the same starting RB and number of RBs and the same cdm-type.

The bandwidth and initial common resource block (CRB) index of a CSI-RS resource within a BWP, as defined in Clause 7.4.1.5 of 3GPP TS 38.211, are determined based on the higher layer parameters nrofRBs and startingRB, respectively, within the CSI-Frequency Occupation IE configured by the higher layer parameter freqBand within the CSI-RS-ResourceMapping IE. Both nrofRBs and startingRB are configured as integer multiples of 4 RBs, and the reference point for startingRB is CRB 0 on the common resource block grid. If startingRB<N_{BWP}^{start}, the UE shall assume that the initial CRB index of the CSI-RS resource is N_{initial RB}=N_{BWP}^{start}, otherwise N_{initial RB}=startingRB. If nrofRBs>N_{BWP}^{size}+N_{BWP}^{start}−N_{initial RB}, the WD shall assume that the bandwidth of the CSI-RS resource is N_{CSI-RS}^{BW}=N_{BWP}^{size}+N_{BWP}^{start}−N_{initial RB}, otherwise N_{CSI-RS}^{BW}=nrof RBs. In all cases, the WD shall expect that N_{CSI-RS}^{BW}≥min (24, N_{BWP}^{size}) NZP-CSI-RS-Resource.

The Information Element (IE) NZP-CSI-RS-Resource is used to configure Non-Zero-Power (NZP) CSI-RS transmitted in a cell where the IE is included, which the WD may be configured to measure on, as described in 3GPP TS 38.214, Clause 5.2.2.3.1. The following is an example of an NZP-CSI-RS-Resource information element.

-- ASN1START
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| | |
|---|---|
| scramblingID | ScramblingId, |
| periodicity AndOffset | CSI-ResourcePeriodicityAndOffset |

OPTIONAL, -- Cond PeriodicOrSemiPersistent

| | |
|---|---|
| qcl-InfoPeriodicCSI-RS | TCI-StateId |

OPTIONAL, -- Cond Periodic
...
}
-- TAG-NZP-CSI-RS-RESOURCE-STOP
-- ASN1STOP

NZP-CSI-RS-Resource fields are described as follows.

TABLE 1.1
NZP-CSI-RS-Resource field descriptions.
NZP-CSI-RS-Resource field descriptions

periodicityAndOffset
Periodicity and slot offset sl1 corresponds to a periodicity of 1 slot, sl2 to a
periodicity of two slots, and so on. The corresponding offset is also given in
number of slots (e.g., see 3GPP TS 38.214, Clause 5.2.2.3.1)
powerControlOffset
Power offset of PDSCH RE to NZP CSI-RS RE. Value in dB (e.g., see 3GPP TS
38.214, Clauses 5.2.2.3.1 and 4.1)
powerControlOffsetSS
Power offset of NZP CSI-RS RE to SS RE. Value in dB (e.g.., see 3GPP TS
38.214, Clause 5.2.2.3.1)
qcl-InfoPeriodicCSI-RS
For a target periodic CSI-RS, contains a reference to one TCI-State in TCI-States
for providing the QCL source and QCL type. For periodic CSI-RS, the source can
be SSB or another periodic-CSI-RS. Refers to the TCI-State which has this value
for tci-StateId and is defined in tci-StatesToAddModList in the PDSCH-Config
included in the BWP-Downlink corresponding to the serving cell and to the DL
BWP to which the resource belongs to (e.g., see 3GPP TS 38.214, Clause
5.2.2.3.1)
resourceMapping
OFDM symbol location(s) in a slot and subcarrier occupancy in a PRB of the CSI-
RS resource
scramblingID
Scrambling ID (e.g., see 3GPP TS 38.214, Clause 5.2.2.3.1)

| Conditional Presence | Explanation |
|---|---|
| Periodic | The field is optionally present, Need M, for periodic NZP- |
| | CSI-RS-Resources (as indicated in CSI-ResourceConfig). |
| | The field is absent otherwise |
| PeriodicOrSemiPersistent | The field is mandatory present, Need M, for periodic and |
| | semi-persistent NZP-CSI-RS-Resources (as indicated in |
| | CSI-ResourceConfig). The field is absent otherwise. |

NZP-CSI-RS-ResourceId

IE NZP-CSI-RS-ResourceId may be used to identify one NZP-CSI-RS-Resource. The following is an example of an IE NZP-CSI-RS-ResourceId.

-- ASN1START
-- TAG-NZP-CSI-RS-RESOURCEID-START

| | |
|---|---|
| NZP-CSI-RS-ResourceId ::= | INTEGER (0..maxNrofNZP-CSI-RS-Resources- |

1)
-- TAG-NZP-CSI-RS-RESOURCEID-STOP
-- ASN1STOP

NZp-CSI-RS-ResourceSet
An IE NZP-CSI-RS-ResourceSet may be set of Non-Zero-Power

(NZP) CSI-RS resources (e.g., IDs) and a set of specific parameters. The following is
an example of an IE NZP-CSI-RS-ResourceSet.
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet))
OF NZP-CSI-RS-ResourceId,

| | |
|---|---|
| repetition | ENUMERATED { on, off } |

| | |
|---|---|
| OPTIONAL, | -- Need S |

| | |
|---|---|
| aperiodicTriggeringOffset | INTEGER(0..6) |

| | |
|---|---|
| OPTIONAL, | -- Need S |

| | |
|---|---|
| trs-Info | ENUMERATED {true} |

| | |
|---|---|
| OPTIONAL, | -- Need R |

...
}
-- TAG-NZP-CSI-RS-RESOURCESET-STOP
-- ASN1STOP

NZP-CSI-RS-Resource fields are described as follows.

TABLE 1.2
NZP-CSI-RS-ResourceSet field descriptions
NZP-CSI-RS-ResourceSetId
IE NZP-CSI-RS-ResourceSetId may be used to identify one NZP-CSI-RS-
ResourceSet. The following is an example of an IE NZP-CSI-RS-ResourceSetId.
NZP-CSI-RS-ResourceSet field descriptions

aperiodicTriggeringOffset
Offset X between the slot containing the DCI that triggers a set of aperiodic NZP
CSI-RS resources and the slot in which the CSI-RS resource set is transmitted. The
value 0 corresponds to 0 slots, value 1 corresponds to 1 slot, value 2 corresponds to
2 slots, value 3 corresponds to 3 slots, value 4 corresponds to 4 slots, value 5
corresponds to 16 slots, value 6 corresponds to 24 slots. When the field is absent
the UE applies the value 0.
nzp-CSI-RS-Resources
NZP-CSI-RS-Resources associated with this NZP-CSI-RS resource set (e.g., see
3GPP TS 38.214, Clause 5.2). For CSI, there are at most 8 NZP CSI RS resources
per resource set.
repetition
Indicates whether repetition is on/off. If the field is set to ‘OFF’ or if the field is
absent, the UE may not assume that the NZP-CSI-RS resources within the resource
set are transmitted with the same downlink spatial domain transmission filter and
with same NrofPorts in every symbol (see TS 38.214 [19], clauses 5.2.2.3.1 and
5.1.6.1.2). Can only be configured for CSI-RS resource sets which are associated
with CSI-ReportConfig with report of L1 RSRP or “no report”
trs-Info
Indicates that the antenna port for all NZP-CSI-RS resources in the CSI-RS
resource set is same. If the field is absent or released the UE applies the value
“false” (e.g., see 3GPP TS 38.214, Clause 5.2.2.3.1).

-- ASN1START
-- TAG-NZP-CSI-RS-RESOURCESETID-START

| | |
|---|---|
| NZP-CSI-RS-ResourceSetId ::= | INTEGER (0..maxNrofNZP-CSI-RS- |

```
ResourceSets-1)
-- TAG-NZP-CSI-RS-RESOURCESETID-STOP
-- ASN1STOP
        CSI-ResourceConfig
        An IE CSI-ResourceConfig defines a group of one or more NZP-CSI-
RS-ResourceSet, CSI-IM-ResourceSet and/or CSI-SSB-ResourceSet. The following
is an example of a CSI-ResourceConfig information element.
```

| | |
|---|---|
| CSI-ResourceConfig ::= | SEQUENCE { |
| csi-ResourceConfigId | CSI-ResourceConfigId, |
| csi-RS-ResourceSetList | CHOICE { |

| | |
|---|---|
| nzp-CSI-RS-SSB | SEQUENCE { |

| | |
|---|---|
| nzp-CSI-RS-ResourceSetList | SEQUENCE (SIZE (1..maxNrofNZP-CSI-RS- |

ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId
OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic |

},
...
}
-- TAG-CSI-RESOURCECONFIG-STOP
-- ASN1STOP

CSI-ResourceConfig field descriptions are described below.

TABLE 1.3
CSI-ResourceConfig field descriptions
CSI-ResourceConfigId
IE CSI-ResourceConfigId is used to identify a CSI-ResourceConfig.
CSI-ResourceConfig field descriptions

bwp-Id
The DL BWP which the CSI-RS associated with this CSI-ResourceConfig are
located in (e.g., see 3GPP TS 38.214, Clause 5.2.1.2)
csi-ResourceConfigId
Used in CSI-ReportConfig to refer to an instance of CSI-ResourceConfig
csi-RS-ResourceSetList
Contains up to maxNrofNZP-CSI-RS-ResourceSetsPerConfig resource sets if
ResourceConfigType is ‘aperiodic’ and 1 otherwise (e.g., see 3GPP TS 38.214,
Clause 5.2.1.2)
csi-SSB-ResourceSetList
List of SSB resources used for beam measurement and reporting in a resource set
(see TS 38.214 [19], section FFS_Section)
resourceType
Time domain behavior of resource configuration (e.g., see 3GPP TS 38.214, Clause
5.2.1.2). It does not apply to resources provided in the csi-SSB-ResourceSetList.

An example of a CSI-ResourceConfigId information element is as follows.

-- ASN1START
-- TAG-CSI-RESOURCECONFIGID-START
CSI-ResourceConfigId ::= INTEGER (0..maxNrofCSI-
ResourceConfigurations-1)
-- TAG-CSI-RESOURCECONFIGID-STOP
-- ASN1STOP

### CSI-ResourcePeriodicityAndOffset

IE CSI-ResourcePeriodicity AndOffset is used to configure a periodicity and a corresponding offset for periodic and semi-persistent CSI resources. For periodic and semi-persistent reporting on PUCCH, the periodicity and the offset are given in number of slots. The periodicity value slots4 corresponds to 4 slots, slots5 corresponds to 5 slots, and so on. An example of a CSI-ResourcePeriodicity AndOffset information element.

| -- ASN1START | |
|---|---|
| -- TAG-CSI-RESOURCEPERIODICITYANDOFFSET-START | |
| CSI-ResourcePeriodicityAndOffset ::= CHOICE { | |
| slots4 | INTEGER (0..3), |
| slots5 | INTEGER (0..4), |
| slots8 | INTEGER (0..7), |
| slots10 | INTEGER (0..9), |
| slots16 | INTEGER (0..15), |
| slots20 | INTEGER (0..19), |
| slots32 | INTEGER (0..31), |
| slots40 | INTEGER (0..39), |
| slots64 | INTEGER (0..63), |
| slots80 | INTEGER (0..79), |
| slots160 | INTEGER (0..159), |
| slots320 | INTEGER (0..319), |
| slots640 | INTEGER (0..639) |

}
-- TAG-CSI-RESOURCEPERIODICITYANDOFFSET-STOP
-- ASN1STOP

### CSI-RS-ResourceMapping

IE CSI-RS-ResourceMapping is used to configure the resource element mapping of a CSI-RS resource in time and frequency domain. An example of a CSI-RS-ResourceMapping information element is as follows.

-- ASN1START
-- TAG-CSI-RS-RESOURCEMAPPING-START

| | |
|---|---|
| CSI-RS-ResourceMapping ::= | SEQUENCE { |

| | |
|---|---|
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED |

{p1,p2,p4,p8,p12,p16,p24,p32},

| | |
|---|---|
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, |

cdm4-FD2-TD2, cdm8-FD2-TD4},

| | |
|---|---|
| density | CHOICE { |
| dot5 | ENUMERATED {evenPRBs, |

oddPRBs},

| | |
|---|---|
| one | NULL, |
| three | NULL, |
| spare | NULL |

},

| | |
|---|---|
| freqBand | CSI-FrequencyOccupation, |

...
}
-- TAG-CSI-RS-RESOURCEMAPPING-STOP
-- ASN1STOP

CSI-RS-ResourceMapping fields are described below.

TABLE 1.4
CSI-RS-ResourceMapping fields
CSI-RS-ResourceMapping field descriptions

cdm-Type
CDM type (e.g., see 3GPP TS 38.214, Clause 5.2.2.3.1).
density
Density of CSI-RS resource measured in RE/port/PRB (e.g., see 3GPP TS 38.211,
Clause 7.4.1.5.3).
Values 0.5 (dot5), 1 (one) and 3 (three) are allowed for X = 1, values 0.5 (dot5) and
1 (one) are allowed for X = 2, 16, 24 and 32, value 1 (one) is allowed for X = 4, 8, 12.
For density = ½, includes 1-bit indication for RB level comb offset indicating
whether odd or even RBs are occupied by CSI-RS.
firstOFDMSymbolInTimeDomain2
Time domain allocation within a physical resource block (e.g., see 3GPP TS
38.211, Clause 7.4.1.5.3.)
firstOFDMSymbolInTimeDomain
Time domain allocation within a physical resource block. The field indicates the
first OFDM symbol in the PRB used for CSI-RS (e.g., see 3GPP TS 38.211, Clause
7.4.1.5.3. Value 2 is supported only when DL-DMRS-typeA-pos equals 3.
freqBand
Wideband or partial band CSI-RS (e.g., see 3GPP TS 38.214, Clause 5.2.2.3.1)
frequencyDomainAllocation
Frequency domain allocation within a physical resource block in accordance with
3GPP TS 38.211, Clause 7.4.1.5.3. The applicable row number in table 7.4.1.5.3-1
is determined by the frequencyDomainAllocation for rows 1, 2 and 4, and for other
rows by matching the values in the column Ports, Density and CDMtype in table
7.4.1.5.3-1 with the values of nrofPorts, cdm-Type and density below and, when
more than one row has the 3 values matching, by selecting the row where the
column (k bar, 1 bar) in table 7.4.1.5.3-1 has indexes for k ranging from 0 to 2*n − 1
where n is the number of bits set to 1 in frequencyDomainAllocation.
nrofPorts
Number of ports (e.g., see 3GPP TS 38.214, Clause 5.2.2.3.1)

### SCell Activation/De-Activation MAC CEs

An SCell Activation/Deactivation MAC CE of one octet is identified by a MAC subheader with Logical Channel ID (LCID) (e.g., see 3GPP TS 38.321, Table 6.2.1-1), which has a fixed size and consists of a single octet containing seven C-fields and one R-field (i.e., Reserve field). FIG. 3 shows an example of a SCell Activation/Deactivation MAC CE with one octet. If there is an SCell configured for the MAC entity with SCellIndex i (e.g., as described in 3GPP TS 38.331), the “Ci” field indicates the activation/deactivation status of the SCell with SCellIndex i. Otherwise, the MAC entity shall ignore the Ci field. The Ci field is set to 1 to indicate that the SCell with SCellIndex i shall be activated. The Ci field is set to 0 to indicate that the SCell with SCellIndex i shall be deactivated. “R” is a Reserved bit, set to 0.

There is another MAC CE of four octets that can support up-to 31 SCell. In this MAC CE signaling, the network node has to indicate clearly an activation status for each configured SCell.

Although 3GPP RANI has agreed to a design based on MAC CE(s) for triggering temporary RS, such as A-TRS for fast SCell activation, several aspects are missing, e.g., details for temporary RS triggering including related RS configuration/signaling and associated MAC CE signaling details.

### SUMMARY

Some embodiments advantageously provide methods, systems, and apparatuses for activation of at least a cell (e.g., a secondary cell, an SCell which may be associated with one or more network nodes and/or more WDs), using at least a reference signal during the activation of the cell. In some other embodiments, a bitmap structure is determined. The bitmap structure is for a WD to obtain A-TRS presence information during a SCell activation procedure, e.g., for secondary cell(s) that are being activated. Determining the bitmap structure may include obtaining additional TRS parameter signaling, e.g., a burst of information in a MAC CE.

In one embodiment, when a predetermined, RRC configured A-TRS resource set is triggered, the MAC CE may include an explicit TCI state identifier to update a TCI state for the A-TRS resource set during the activation procedure. In another embodiment, configuration of A-TRS triggers a state list, e.g., for the purpose of SCell activation. Use of MAC CE to indicate one or more trigger states is described, where the trigger states may be obtained from A-TRS trigger state list to indicate the TRS presence during SCell activation.

In some embodiments, a trigger state ID is received in a MAC CE during SCell activation. In some other embodiments, the trigger state ID indicates a trigger state in a first list of trigger states (e.g., a list configured by RRC), where each trigger state is associated with one or more NZP-CSI RS resource sets to be used as CSI RS for tracking, which is also referred to as aperiodic tracking reference signals or A-TRS(s). In one embodiment, SCell activation is performed with an adjusted activation delay by using A-TRS(s) associated with a trigger state ID. The activation delay is adjusted in relation to a delay where some parameters are not received, e.g., the activation delay is adjusted to be smaller than a delay needed when the trigger state ID and associated A-TRS(s) are not received.

In another embodiment, a first list is a separate list from a second list, e.g., a legacy list, of trigger states, e.g., configured by RRC, with each trigger state of the second list being associated with one or more NZP-CSI RS resource sets to be used as CSI RS perform any one of aperiodic CSI (A-CSI) reporting, LI RSRP reporting, interference measurements and tracking. The second list is used for general A-CSI reporting, where a corresponding trigger state ID is indicated using bits in a PDCCH DCI format used for A-CSI request.

In some other embodiments, a clear and efficient process is provided to configure and trigger A-TRS via MAC CE for fast SCell activation. Having a separate RRC configured trigger state list for A-TRS triggering via MAC CE during SCell activation (i.e., separate from a legacy list used for A-CSI reporting triggered via DCI) allows triggering A-TRS(s) for SCell activation without added DCI overhead for triggering of A-CSI request.

According to one aspect, a network node configured to communicate with a wireless device, WD, is described. The network node comprises processing circuitry and a radio interface in communication with the processing circuitry. The processing circuitry is configured to determine a reference signal presence message including presence information of at least one reference signal for an activation of at least one secondary cell, the presence information including at least one index indicating a trigger state from a trigger state list. The radio interface is configured to transmit the reference signal presence message and receive a report from the WD indicating that the activation of at least one secondary cell using the at least one reference signal is complete.

In some embodiments, at least one of: the WD is configured with a first set of secondary cells, and the radio interface is further configured to transmit an activation message indicating at least a secondary cell activation of a second set of secondary cells, the at least one reference signal, the transmitted reference signal message, and the transmitted activation message being usable by the WD, in part, to activate the at least one secondary cell.

In some other embodiments, each index of the at least one index corresponds to one secondary cell of the first set of secondary cells.

In one embodiment, each trigger state of the trigger state list is associated with at least one non-zero power channel state information reference signal, NZP CSI RS, resource set.

In another embodiment, each trigger state of the trigger state list is associated with at least one transmission configuration information, TCI, state providing a quasi-location source at least for one corresponding NZP resource set.

In some embodiments, the at least one TCI state is indicated by a TCI state identifier.

In some other embodiments, at least one trigger state of the trigger state list triggers one reference signal on at least one cell.

In one embodiment, the trigger state list includes a first trigger state list and a second trigger state list. The first trigger state list corresponds to at least one trigger state associated with latency of the activation of the at least one secondary cell. The second trigger state list corresponds to at least one type of channel state information reference signal, CSI RS.

In another embodiment, the at least one reference signal is a tracking reference signal, TRS, and the report is a completion channel state information reference signal, CSI, report.

In some embodiments, the network node is configured to communicate with the WD using at least a primary cell.

According to another aspect, a method in a network node configured to communicate with a wireless device, WD, is described. The method comprises: determining a reference signal presence message including presence information of at least one reference signal for an activation of at least one secondary cell, where the presence information includes at least one index indicating a trigger state from a trigger state list: transmitting the reference signal presence message: and receiving a report from the WD indicating that the activation of at least one secondary cell using the at least one reference signal is complete.

In some embodiments, at least one of the WD is configured with a first set of secondary cells, and the method further includes transmitting an activation message indicating at least a secondary cell activation of a second set of secondary cells, the at least one reference signal, the transmitted reference signal message, and the transmitted activation message being usable by the WD, in part, to activate the at least one secondary cell.

In some other embodiments, each index of the at least one index corresponds to one secondary cell of the first set of secondary cells.

In one embodiment, each trigger state of the trigger state list is associated with at least one non-zero power channel state information reference signal, NZP CSI RS, resource set.

In another embodiment, each trigger state of the trigger state list is associated with at least one transmission configuration information, TCI, state providing a quasi-location source at least for one corresponding NZP resource set.

In some embodiments, the at least one TCI state is indicated by a TCI state identifier.

In some other embodiments, at least one trigger state of the trigger state list triggers one reference signal on at least one cell.

In one embodiment, the trigger state list includes a first trigger state list and a second trigger state list. The first trigger state list corresponds to at least one trigger state associated with latency of the activation of the at least one secondary cell. The second trigger state list corresponds to at least one type of channel state information reference signal, CSI RS.

In another embodiment, the at least one reference signal is a tracking reference signal, TRS, and the report is a completion channel state information reference signal, CSI, report.

In some embodiments, the network node is configured to communicate with the WD using at least a primary cell.

According to one aspect, a wireless device, WD, configured to communicate at least with a network node is described. The WD comprises processing circuitry and a radio interface in communication with the processing circuitry. The radio interface is configured to: receive a reference signal presence message including presence information of at least one reference signal for an activation of at least one secondary cell, the presence information including at least one index indicating a trigger state from a trigger state list: and receive the at least one reference signal. The processing circuitry is configured to complete the activation of the at least one secondary cell based at least in part on the received reference signal presence message and the received at least one reference signal.

In some embodiments, at least one of the WD is configured with a first set of secondary cells, and the radio interface is further configured to receive an activation message indicating at least a secondary cell activation of a second set of secondary cells. Completing the activation of the at least one secondary cell is further based on the activation message.

In some other embodiments, each index of the at least one index corresponds to one secondary cell of the first set of secondary cells.

In one embodiment, each trigger state of the trigger state list is associated with at least one non-zero power channel state information reference signal, NZP CSI RS, resource set.

In another embodiment, each trigger state of the trigger state list is associated with at least one transmission configuration information, TCI, state providing a quasi-location source at least for one corresponding NZP resource set.

In some embodiments, the at least one TCI state is indicated by a TCI state identifier.

In some other embodiments, at least one trigger state of the trigger state list triggers one reference signal on at least one cell.

In one embodiment, the trigger state list includes a first trigger state list and a second trigger state list. The first trigger state list corresponds to at least one trigger state associated with latency of the activation of the at least one secondary cell. The second trigger state list corresponds to at least one type of channel state information reference signal, CSI RS.

In another embodiment, the at least one reference signal is a tracking reference signal, TRS. Completing the activation of the at least one secondary cell includes transmitting a report indicating that the activation of at least one secondary cell using the at least one reference signal is complete. The report is a completion channel state information reference signal, CSI, report.

In some embodiments, the WD is configured to communicate with the network node 16 using at least a primary cell.

According to another aspect, a method in a wireless device, WD, is described. The WD is configured to communicate at least with a network node. The method comprises: receiving a reference signal presence message including presence information of at least one reference signal for an activation of at least one secondary cell, the presence information including at least one index indicating a trigger state from a trigger state list: receiving the at least one reference signal; and completing the activation of the at least one secondary cell based at least in part on the received reference signal presence message and the received at least one reference signal.

In some embodiments, at least one of the WD is configured with a first set of secondary cells, and the method further includes receiving an activation message indicating at least a secondary cell activation of a second set of secondary cells. Completing the activation of the at least one secondary cell is further based on the activation message.

In some other embodiments, each index of the at least one index corresponds to one secondary cell of the first set of secondary cells.

In one embodiment, each trigger state of the trigger state list is associated with at least one non-zero power channel state information reference signal, NZP CSI RS, resource set.

In another embodiment, each trigger state of the trigger state list is associated with at least one transmission configuration information, TCI, state providing a quasi-location source at least for one corresponding NZP resource set.

In some embodiments, the at least one TCI state is indicated by a TCI state identifier.

In some other embodiments, at least one trigger state of the trigger state list triggers one reference signal on at least one cell.

In one embodiment, the trigger state list includes a first trigger state list and a second trigger state list. The first trigger state list corresponds to at least one trigger state associated with latency of the activation of the at least one secondary cell. The second trigger state list corresponds to at least one type of channel state information reference signal, CSI RS.

In another embodiment, the at least one reference signal is a tracking reference signal, TRS. Completing the activation of the at least one secondary cell includes transmitting a report indicating that the activation of at least one secondary cell using the at least one reference signal is complete. The report is a completion channel state information reference signal, CSI, report.

In some embodiments, the WD is configured to communicate with the network node using at least a primary cell.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example of a legacy SCell activation process:

FIG. 2 shows an example of SCell activation process utilizing temporary RS:

FIG. 3 shows an example of SCell Activation/Deactivation MAC CE of one octet:

FIG. 4 is a schematic diagram of an example network architecture illustrating a communication system connected via an intermediate network to a host computer according to the principles in the present disclosure:

FIG. 5 is a block diagram of a host computer communicating via a network node with a wireless device over an at least partially wireless connection according to some embodiments of the present disclosure:

FIG. 6 is a flowchart illustrating example methods implemented in a communication system including a host computer, a network node and a wireless device for executing a client application at a wireless device according to some embodiments of the present disclosure:

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure:

FIG. 9 is a flowchart illustrating example methods implemented in a communication system including a host computer, a network node and a wireless device for receiving user data at a host computer according to some embodiments of the present disclosure:

FIG. 10 is a flowchart of an example process in a network node for transmitting at least a reference signal for activation of another network node, e.g., a SCell, according to some embodiments of the present disclosure:

FIG. 11 is a flowchart of an example process in a wireless device for receiving at least a reference signal for activation of a second network node, e.g., the SCell, and complete the activation of the second network node according to some embodiments of the present disclosure:

FIG. 12 is a flowchart of another example process in a network node according to some embodiments of the present disclosure:

FIG. 13 is a flowchart of another example process in a wireless device according to some embodiments of the present disclosure:

FIG. 14 shows an example of activation of SCells using an activation/deactivation message and a TRS bitmap message according to some embodiments of the present disclosure;

FIG. 15 shows an example of configurations where TRS is present according to some embodiments of the present disclosure:

FIG. 16 shows another example of configurations where TRS is present according to some embodiments of the present disclosure:

FIG. 17 shows an example of configurations where the CSI triggering offset and burst information are explicitly included in a message according to some embodiments of the present disclosure:

FIG. 18 shows an example of configurations grouped by trigger state identification according to some embodiments of the present disclosure;

FIG. 19 shows an example of MAC CE messages using a trigger state list for activating at least a network node that is a SCell according to some embodiments of the present disclosure:

FIG. 20 shows an example configuration for a serving cell with ID a1 and a serving cell with ID a2, respectively, according to some embodiments of the present disclosure: and

FIG. 21 shows another MAC CE using a trigger state list for activating a SCell according to some embodiments of the present disclosure.

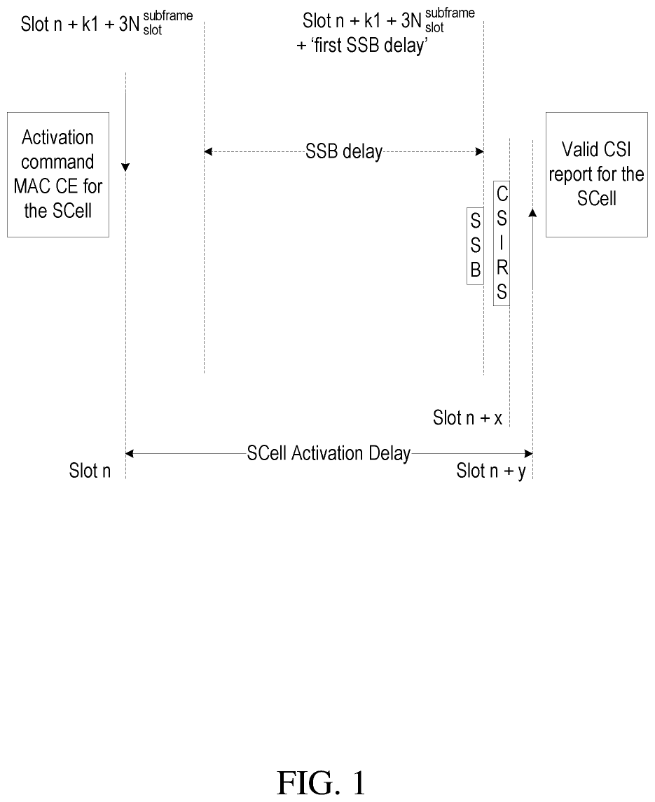

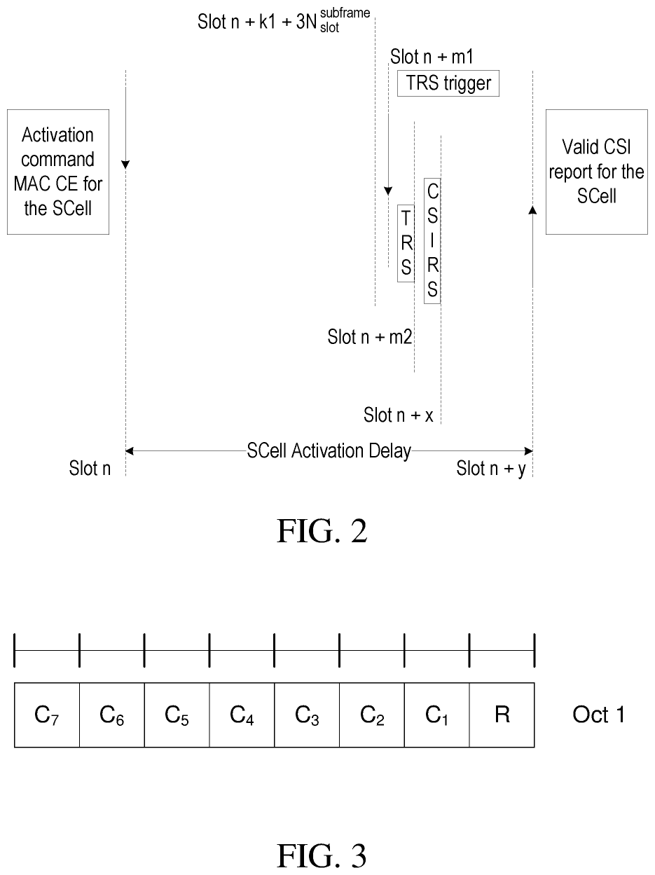

### DETAILED DESCRIPTION

Before describing in detail exemplary embodiments, it is noted that the embodiments reside primarily in combinations of apparatus components and processing steps related to activation of at least one cell (e.g., a secondary cell, an SCell which may be associated with one or more network nodes and/or one or more WDs) using at least a reference signal during the activation of the cell, e.g., the SCell. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The network node and/or the WD may be configured to transmit/receive one or more messages. Each message may be and/or comprise an activation message and/or deactivation message and/or a bitmap message such as a TRS bitmap message and/or a presence message such as a reference signal presence message, a TRS presence message, etc. and/or a MAC CE message and/or any other type of message. A message may include one or more fields and/or information such as serving cell ID NZP resource set ID, TCI-State ID, CSI triggering offset, burst information, trigger State ID, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide activation of at least a cell (e.g., a secondary cell, a SCell, etc.) using at least a reference signal (e.g., a TRS) during the activation of the cell.

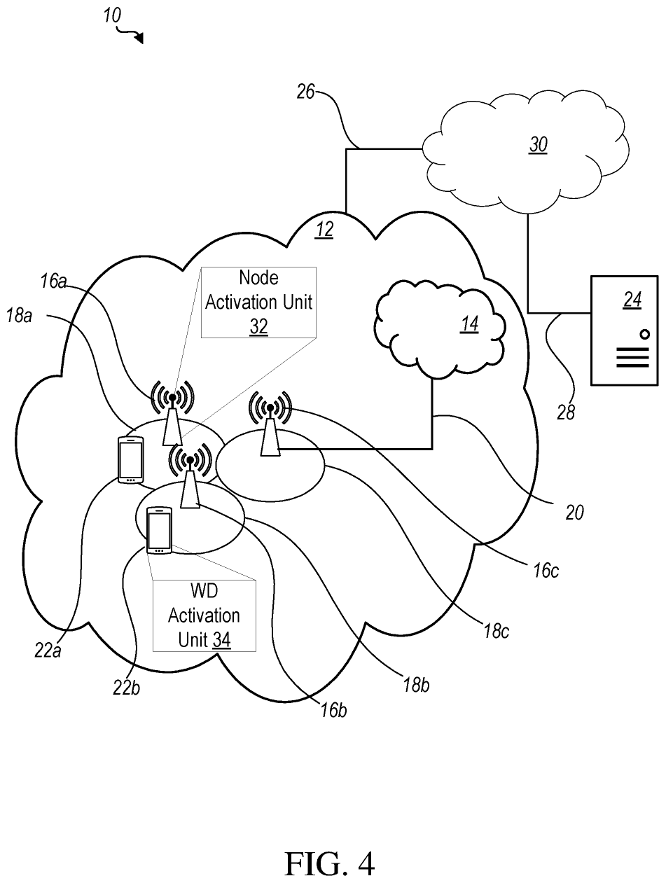

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Coverage area 18 may refer to one or more cell such as an PCell and/or SCell and/or any other type of cell. Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. Any one of the network nodes 16 may be and/or communicate with one or more WDs 22 using a cell such as a Primary Cell (PCell) and/or a Secondary Cell (SCell). However, any one of the network nodes 16 are not limited to being and/or communicate using the cell such as the PCell and/or the SCell and may be and/or communicate using any kind of cell.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a node activation unit 32 which is configured to perform any step and/or method and/or process and/or function and/or feature described in the present disclosure, e.g., at least one of: determine a reference signal presence message including presence information of at least one reference signal for an activation of at least one secondary cell, where the presence information includes at least one index indicating a trigger state from a trigger state list: cause the network node 16 and/or another network node 16 to transmit at least a reference signal for activation of at least one cell, e.g., a SCell: cause the network node 16 to transmit the reference signal presence message: and cause the network node 16 to receive a report from the WD 22 indicating that the activation of at least one secondary cell using the at least one reference signal is complete. A wireless device 22 is configured to include a WD activation unit 34 which is configured to perform any step and/or method and/or process and/or function and/or feature described in the present disclosure, e.g., at least one of: cause the WD 22 to receive at least a reference signal for activation of a network node, e.g., associated with the SCell: cause the WD 22 to receive a reference signal presence message including presence information of at least one reference signal for an activation of at least one secondary cell, the presence information including at least one index indicating a trigger state from a trigger state list: and complete the activation of the other network node.

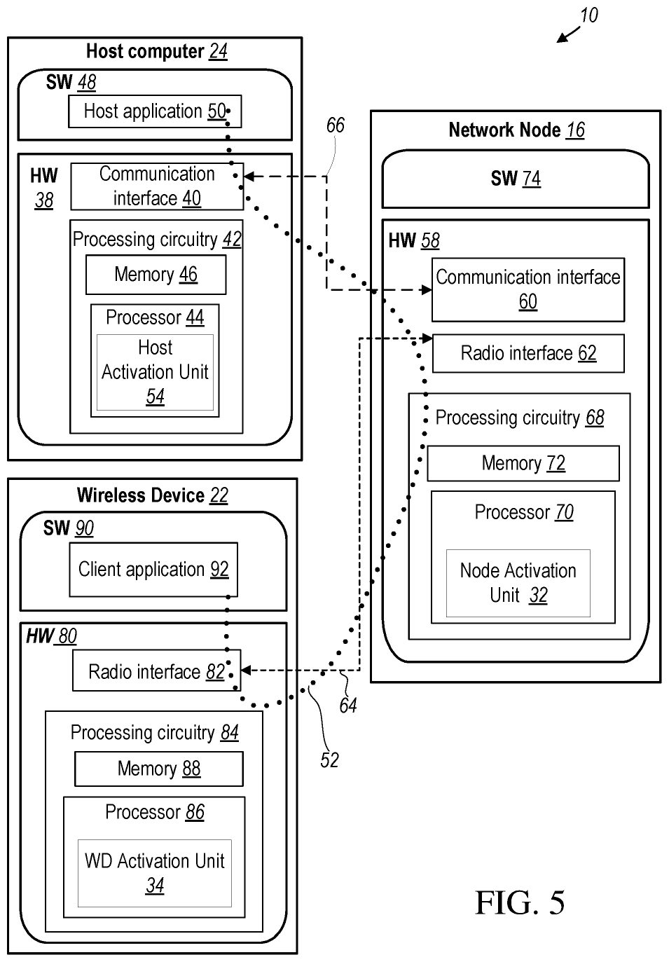

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host activation unit 54 configured to perform any step and/or method and/or process and/or function and/or feature described in the present disclosure, e.g., enabling the service provider to observe/monitor/control/transmit to/receive from the network node 16 and or the wireless device 22 in accordance with the activation of at least one cell, e.g., SCell, using at least a reference signal during the activation of the cell, e.g., the SCell.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include node activation unit 32 configured to perform any step and/or method and/or process and/or function and/or feature described in the present disclosure, e.g., at least one of: determine a reference signal presence message including presence information of at least one reference signal for an activation of at least one secondary cell, where the presence information includes at least one index indicating a trigger state from a trigger state list: cause the network node 16 and/or another network node 16 to transmit at least a reference signal for activation of at least one cell, e.g., a SCell; cause the network node 16 to transmit the reference signal presence message; and cause the network node 16 to receive a report from the WD 22 indicating that the activation of at least one secondary cell using the at least one reference signal is complete.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD activation unit 34 configured to perform any step and/or method and/or process and/or function and/or feature described in the present disclosure, e.g., at least one of: cause the WD 22 to receive at least a reference signal for activation of a network node, e.g., associated with the SCell: cause the WD 22 to receive a reference signal presence message including presence information of at least one reference signal for an activation of at least one secondary cell, the presence information including at least one index indicating a trigger state from a trigger state list: and complete the activation of the other network node.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes: the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as node activation unit 32, and WD activation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

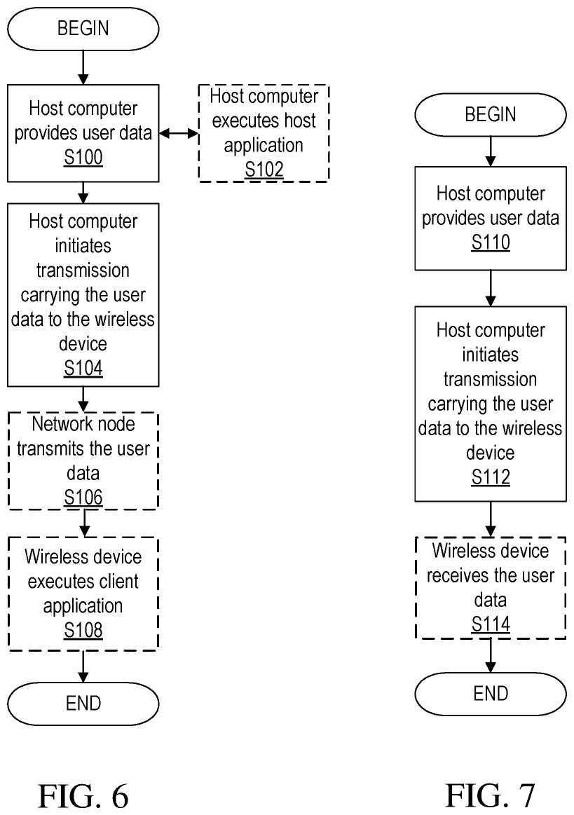

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

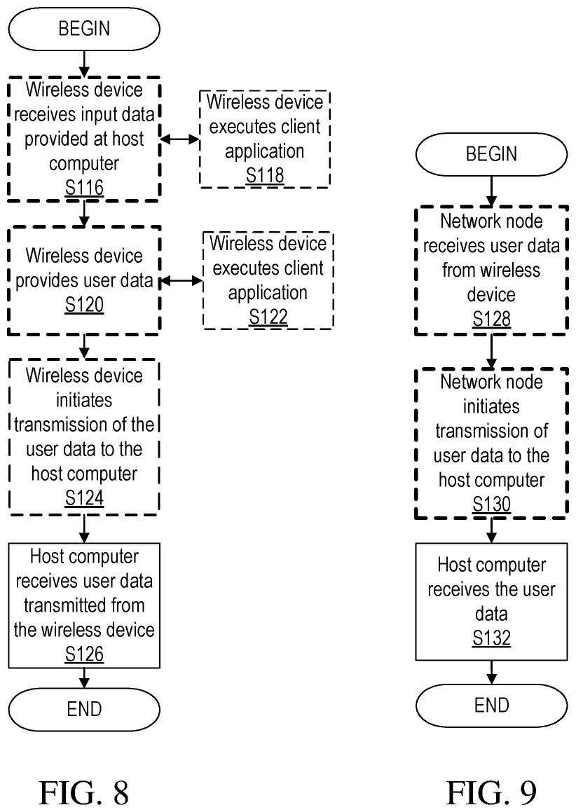

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

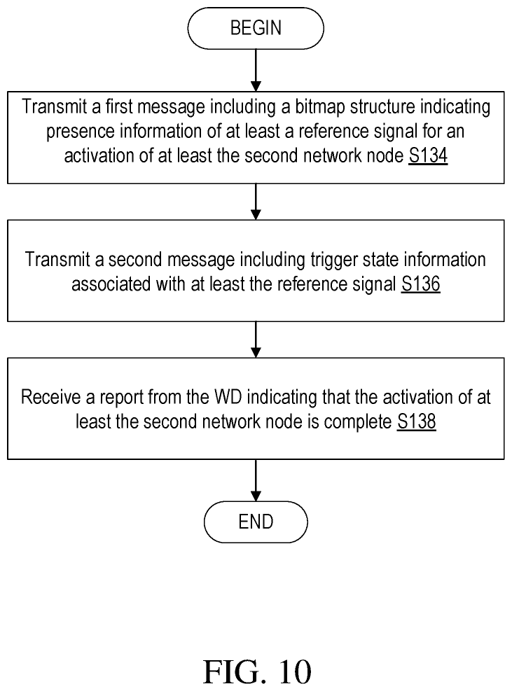

FIG. 10 is a flowchart of an example process in a network node 16 for transmitting at least a reference signal for activation of another network node, e.g., a SCell. One or more blocks described herein may be performed by one or more elements of network node 16 such as by one or more of processing circuitry 68 (including the node activation unit 32), processor 70, radio interface 62 and/or communication interface 60. Network node 16 such as via processing circuitry 68 and/or processor 70 and/or radio interface 62 and/or communication interface 60 is configured to transmit (Block S134) a first message including a bitmap structure indicating presence information of at least a reference signal for an activation of at least the second network node, transmit (Block S136) a second message including trigger state information associated with at least the reference signal, and receive (Block S138) a report from the WD indicating that the activation of at least the second network node is complete.

In some embodiments, the trigger state information includes a trigger state identification that indicates a trigger state in a first list of trigger states, and each trigger state of the first list of trigger states is associated with at least a first resource set to be used as the reference signal. The first list of trigger states is preconfigured on the WD, and the first resource set is a NZP-CSI RS resource set for one of a Channel State Information Reference Signal (CSI-RS) tracking and an Aperiodic Tracking Reference Signal (A-TRS).

In some other embodiments, the first list is a separate list from a second list of trigger states, and each trigger state of the second list is associated with a second resource set for a CSI-RS. The CSI-RS is used for any one of an aperiodic CSI report, an RSRP report, interference measurements and tracking. The aperiodic CSI report corresponds to at least to another trigger state identification including bits in a Physical Downlink Control Channel Downlink Control Information (PDCCH DCI) format used for an aperiodic CSI request.

In one embodiment, the second message further indicates any one of: a cell identification, a Transmission Configuration Indication (TCI) state identification, and an NZP recourse set identification corresponding to the second network node; the Transmission Configuration Indication (TCI) state identification and the NZP recourse set identification corresponding to the second network node; and the Transmission Configuration Indication (TCI) state identification, the NZP resource set identification corresponding to the second network node, CSI triggering offset, and burst information.

In another embodiment, the trigger state identification corresponds at least to the cell identification, the NZP resource set identification and the TCI state identification.

In some embodiments, the cell identification is part of a plurality cell identifications, and each cell identification of the plurality of cell identifications corresponds to any one of one NZP resource set identification and once TCI state identification.

In one embodiment, a plurality of TCI state identifications corresponds to at least one NZP resource set identification of a plurality of NZP resource sets. In another embodiment, the first network node is Primary Cell (PCell) and the second network node is Secondary Cell (SCell). In some embodiments, the reference signal is a temporary reference signal, which is a tracking reference signal (TRS). In some other embodiments, each bit of the bitmap structure included in the first message indicates any one of another reserve bit, the reference signal for the activation of the second network node, and another reference signal for another activation of another network node.

In one embodiment, the first network node and/or the radio interface and/or the processing circuitry is further configured to: transmit an activation command, where the activation command is another bitmap structure, and each bit of the other bitmap structure indicates any one of a reserve bit, an activation, and a deactivation associated with a group of network nodes; one of cause the WD to determine a subgroup of the group of network nodes and transmit a third message indicating the subgroup, where the second network node is part of the subgroup; and cause the WD to initiate the activation of at least of the second network node based at least on the second message.

In another embodiment, the first network node and/or the radio interface and/or the processing circuitry is further configured to cause the WD to determine that at least the reference signal corresponds to the activation of at least the second network node based at least on the activation command and the first message.

In some embodiments, any one of the first message, the second message, and the activation command is received in a Medium Access Control (MAC) Control Element (CE). In some other embodiments, receiving the report from the WD includes receiving a completion CSI report for the at least the second network node. In one embodiment, indicating that the activation of at least the second network node is complete includes a completion indication of an activation of more network nodes than a total number of reference signals indicated by the bitmap structure of the first message.

In another embodiment, the first message explicitly indicates that the at least reference signal is predetermined. In some embodiments, a Quasi Co-Located (QCL) source for the at least reference signal is explicitly indicated at least in the second message. In some other embodiments, the first network node and/or the radio interface and/or the processing circuitry is further configured to transmit a plurality of bursts of reference signals to cause the WD to perform Automatic Gain Control (AGC).

In one embodiment, the first network node and the second network node operate using a same beam based on a unified Transmission Configuration Indication (TCI) state for one of a downlink and an uplink transmission.

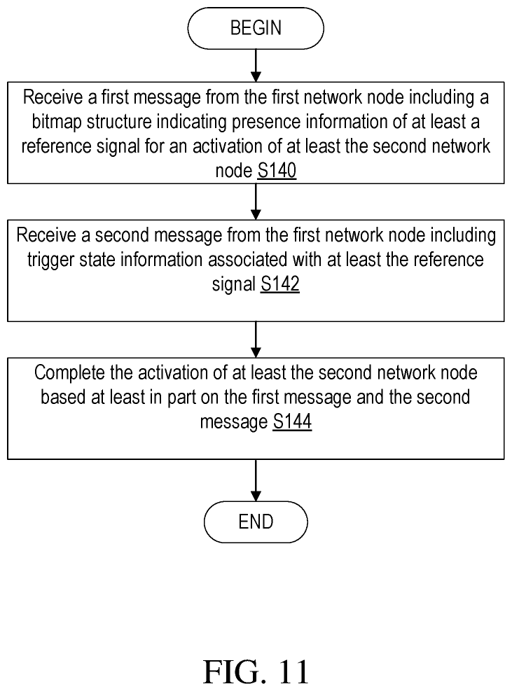

FIG. 11 is a flowchart of an example process in a wireless device 22 according to some embodiments of the present disclosure for receiving at least a reference signal for activation of a second network node, e.g., the SCell, and complete the activation of the second network node. One or more blocks described herein may be performed by one or more elements of wireless device 22 such as by one or more of processing circuitry 84 (including the WD activation unit 34), processor 86, radio interface 82 and/or communication interface 60. Wireless device 22 such as via processing circuitry 84 and/or processor 86 and/or radio interface 82 is configured to receive (Block S140) a first message from the first network node including a bitmap structure indicating presence information of at least a reference signal for an activation of at least the second network node, receive (Block S142) a second message from the first network node including trigger state information associated with at least the reference signal, and complete (Block S144) the activation of at least the second network node based at least in part on the first message and the second message.

In some embodiments, the trigger state information includes a trigger state identification indicating a trigger state in a first list of trigger states, and each trigger state of the first list of trigger states is associated with at least a first resource set to be used as the reference signal. The first list of trigger states are preconfigured on the WD, and the first resource set is a NZP-CSI RS resource set for one of a Channel State Information Reference Signal (CSI-RS) tracking and an Aperiodic Tracking Reference Signal (A-TRS).

In some other embodiments, the first list is a separate list from a second list of trigger states, and each trigger state of the second list is associated with a second resource set for a CSI-RS. The CSI-RS is used for any one of an aperiodic CSI report, an RSRP report, interference measurements and tracking. The aperiodic CSI report corresponds to at least to another trigger state identification including bits in a Physical Downlink Control Channel Downlink Control Information (PDCCH DCI) format used for an aperiodic CSI request.

In an embodiment, the second message further indicates any one of: a cell identification, a Transmission Configuration Indication (TCI) state identification, and an NZP recourse set identification corresponding to the second network node: the Transmission Configuration Indication (TCI) state identification and the NZP recourse set identification corresponding to the second network node; and the Transmission Configuration Indication (TCI) state identification, the NZP resource set identification corresponding to the second network node, CSI triggering offset, and burst information.

In another embodiment, the trigger state identification corresponds at least to the cell identification, the NZP resource set identification and the TCI state identification. In some embodiments, the cell identification is part of a plurality cell identifications, and each cell identification of the plurality of cell identifications corresponds to any one of one NZP resource set identification and once TCI state identification. In some other embodiments, a plurality of TCI state identifications corresponds to at least one NZP resource set identification of a plurality of NZP resource sets. In one embodiment, the first network node is Primary Cell (PCell) and the second network node is Secondary Cell (SCell). In another embodiment, the reference signal is a temporary reference signal, which is a tracking reference signal (TRS)

In some embodiments, each bit of the bitmap structure included in the first message indicates any one of another reserve bit, the reference signal for the activation of the second network node, and another reference signal for another activation of another network node.

In some other embodiments, the WD and/or the radio interface and/or the processing circuitry is further configured to: receive an activation command, the activation command being another bitmap structure, where each bit of the other bitmap structure indicates any one of a reserve bit, an activation, and a deactivation associated with a group of network nodes: one of determine a subgroup of the group of network nodes and receive a third message indicating the subgroup, the second network node being part of the subgroup; and initiate the activation of at least of the second network node based at least on the second message.

In one embodiment, the WD and/or the radio interface and/or the processing circuitry is further configured to determine that at least the reference signal corresponds to the activation of at least the second network node based at least on the activation command and the first message.

In another embodiment, any one of the first message, the second message, and the activation command is received in a Medium Access Control (MAC) Control Element (CE). In some embodiments, completing the activation of at least the second network node includes transmitting a completion CSI report for the at least the second network node. In some other embodiments, completing the activation of at least the second network node includes a completion of an activation of more network nodes than a total number of reference signals indicated by the bitmap structure of the first message. In one embodiment, the first message explicitly indicates that the at least reference signal is predetermined. In another embodiment, a Quasi Co-Located (QCL) source for the at least reference signal is explicitly indicated at least in the second message. In some embodiments, the WD is and/or the radio interface and/or the processing circuitry further configured to receive a plurality of bursts of reference signals to perform Automatic Gain Control (AGC). In some other embodiments, the first network node and the second network node operate using a same beam based on a unified Transmission Configuration Indication (TCI) state for one of a downlink and an uplink transmission.

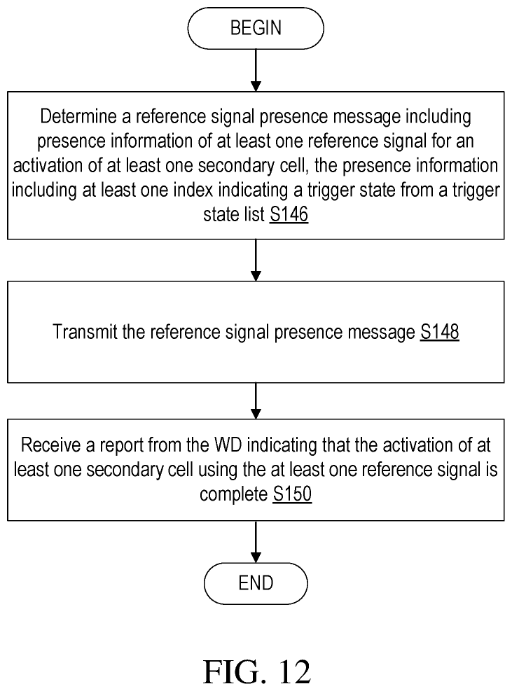

FIG. 12 is a flowchart of another example process in a network node 16 according to some embodiments of the present disclosure. One or more blocks described herein may be performed by one or more elements of network node 16 such as by one or more of processing circuitry 68 (including the node activation unit 32), processor 70, radio interface 62 and/or communication interface 60. Network node 16 such as via processing circuitry 68 and/or processor 70 and/or radio interface 62 and/or communication interface 60 is configured to determine (Block S146) a reference signal presence message including presence information of at least one reference signal for an activation of at least one secondary cell, where the presence information includes at least one index indicating a trigger state from a trigger state list: transmit (Block S148) the reference signal presence message: and receive (Block S150) a report from the WD 22 indicating that the activation of at least one secondary cell using the at least one reference signal is complete.

In some embodiments, at least one of: the WD 22 is configured with a first set of secondary cells, and the method further includes transmitting an activation message indicating at least a secondary cell activation of a second set of secondary cells, the at least one reference signal, the transmitted reference signal message, and the transmitted activation message being usable by the WD 22, in part, to activate the at least one secondary cell.

In some other embodiments, each index of the at least one index corresponds to one secondary cell of the first set of secondary cells.

In one embodiment, each trigger state of the trigger state list is associated with at least one non-zero power channel state information reference signal, NZP CSI RS, resource set.

In another embodiment, each trigger state of the trigger state list is associated with at least one transmission configuration information, TCI, state providing a quasi-location source at least for one corresponding NZP resource set.

In some embodiments, the at least one TCI state is indicated by a TCI state identifier.

In some other embodiments, at least one trigger state of the trigger state list triggers one reference signal on at least one cell.

In one embodiment, the trigger state list includes a first trigger state list and a second trigger state list. The first trigger state list corresponds to at least one trigger state associated with latency of the activation of the at least one secondary cell. The second trigger state list corresponds to at least one type of channel state information reference signal, CSI RS.

In another embodiment, the at least one reference signal is a tracking reference signal, TRS, and the report is a completion channel state information reference signal, CSI, report.

In some embodiments, the network node 16 is configured to communicate with the WD 22 using at least a primary cell.

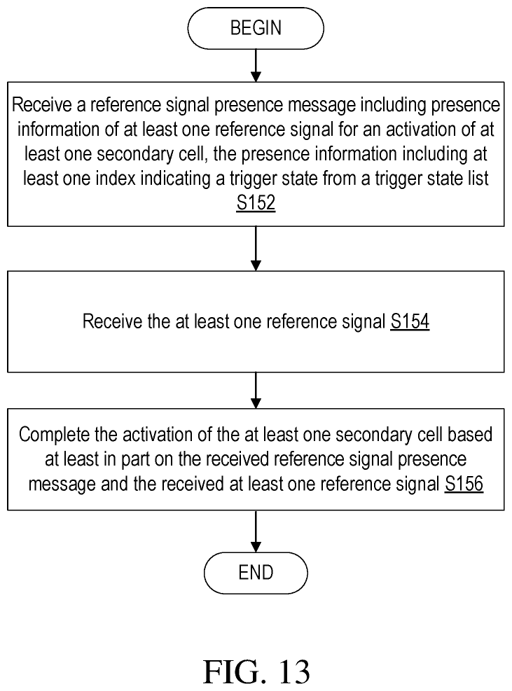

FIG. 13 is a flowchart of another example process in a wireless device 22 according to some embodiments of the present disclosure. One or more blocks described herein may be performed by one or more elements of wireless device 22 such as by one or more of processing circuitry 84 (including the WD activation unit 34), processor 86, radio interface 82 and/or communication interface 60. Wireless device 22 such as via processing circuitry 84 and/or processor 86 and/or radio interface 82 is configured to receive (Block S152) a reference signal presence message including presence information of at least one reference signal for an activation of at least one secondary cell, where the presence information includes at least one index indicating a trigger state from a trigger state list: receive (Block S154) the at least one reference signal: and complete (Block S156) the activation of the at least one secondary cell based at least in part on the received reference signal presence message and the received at least one reference signal.

In some embodiments, at least one of the WD 22 is configured with a first set of secondary cells, and the method further includes receiving an activation message indicating at least a secondary cell activation of a second set of secondary cells. Completing the activation of the at least one secondary cell is further based on the activation message.

In some other embodiments, each index of the at least one index corresponds to one secondary cell of the first set of secondary cells.

In one embodiment, each trigger state of the trigger state list is associated with at least one non-zero power channel state information reference signal, NZP CSI RS, resource set.

In another embodiment, each trigger state of the trigger state list is associated with at least one transmission configuration information, TCI, state providing a quasi-location source at least for one corresponding NZP resource set.

In some embodiments, the at least one TCI state is indicated by a TCI state identifier.

In some other embodiments, at least one trigger state of the trigger state list triggers one reference signal on at least one cell.

In one embodiment, the trigger state list includes a first trigger state list and a second trigger state list. The first trigger state list corresponds to at least one trigger state associated with latency of the activation of the at least one secondary cell. The second trigger state list corresponds to at least one type of channel state information reference signal, CSI RS.

In another embodiment, the at least one reference signal is a tracking reference signal, TRS. Completing the activation of the at least one secondary cell includes transmitting a report indicating that the activation of at least one secondary cell using the at least one reference signal is complete. The report is a completion channel state information reference signal, CSI, report.

In some embodiments, the WD 22 is configured to communicate with the network node 16 using at least a primary cell.

Having described the general process flow of arrangements of the disclosure and having provided examples of hardware and software arrangements for implementing the processes and functions of the disclosure, the sections below provide details and examples of arrangements for activation of at least a cell, e.g., SCell, using at least a reference signal during the activation of the cell, e.g., the SCell.

A WD 22 may be configured to communicate with a network node 16, e.g., using a PCell. The WD 22 may also be configured to communicate with the network node 16 (and/or another network node 16), e.g., using a SCell. Further, the WD 22 may be configured with temporary reference signals for one or more SCells. In other words, network node 16 and/or WD 22 may be configured to communicate using one or more cells, such as a PCell, SCell, and/or any other type of cell, where each of the cells may be activated and/or caused to be activated by network node 16 and/or WD 22. A temporary reference signal may be a tracking reference signal or a CSI-RS for tracking. The configuration of the temporary reference signal for a cell, e.g., a SCell, can include at least one or more of the following: (1) a non-zero power CSI-Resource set Identifier: and (2) TCI-state identifier to indicate the QCL source for the temporary reference signal. The TCI state identifier provides the QCL source for TypeC QCL and/or TypeD QCL.

In some embodiments, sending a temporary RS for less than all secondary cells, e.g., activated SCells, is supported. In other words, whether a temporary RS is triggered or present during the activation of a SCell is independently controlled from the activation of the SCell. In this example, for each SCell, there may be one non-zero power CSI-Resource Set Identifier and/or one TCI-state Identifier configured by RRC. When a MAC CE triggering is transmitted from network node 16 to WD 22, the RRC configured temporary reference signal is triggered/transmitted from network node 16.

The network node 16 may send an activation command to WD 22 to activate multiple SCells, but network node 16 may trigger temporary RS for a subset of the multiple SCells. For example, network node 16 may indicate to WD 22 to activate two FR1 and FR2 SCells, but network node 16 sends temporary RS for faster activation of secondary cells corresponding to FR1, while the WD 22 has to activate other cells corresponding to FR2 without receiving temporary RS for the FR2 cells. Sending temporary RS for only some cells could, for example, depend on traffic needs, delays, etc. Thus, network node 16 may, or may not, trigger temporary RS for a cell, e.g., SCell, that is being activated. Additional details about this process are provided below.

A WD 22 receives an activation command, e.g., a SCell activation command, indicating activation and/or deactivation status of cells such as secondary cells that are already configured for the WD 22. The WD 22 receives the activation command including information about the secondary cells for which temporary RS is triggered, e.g., temporary RS trigger command. For example, the command may include a bitmap, e.g., temporary RS bitmap or TRS bitmap, where each bit of the bitmap is associated with a cell, such as a secondary cell configured for WD 22. If a bit for a secondary cell is set to a first value (e.g., 1), and the secondary cell is being activated (e.g., per SCell activation command), the temporary RS for the corresponding secondary cell is present during activation. If a bit for a secondary cell is set to a second value (e.g., 0), and the secondary cell is being activated (e.g., per SCell activation command), the temporary RS for the corresponding secondary cell is not present, and WD 22 follows regular activation timeline associated with SCells (e.g., not relying on temporary RS for activation). For secondary cells that are deactivated, the bit in the bitmap can be reserved.

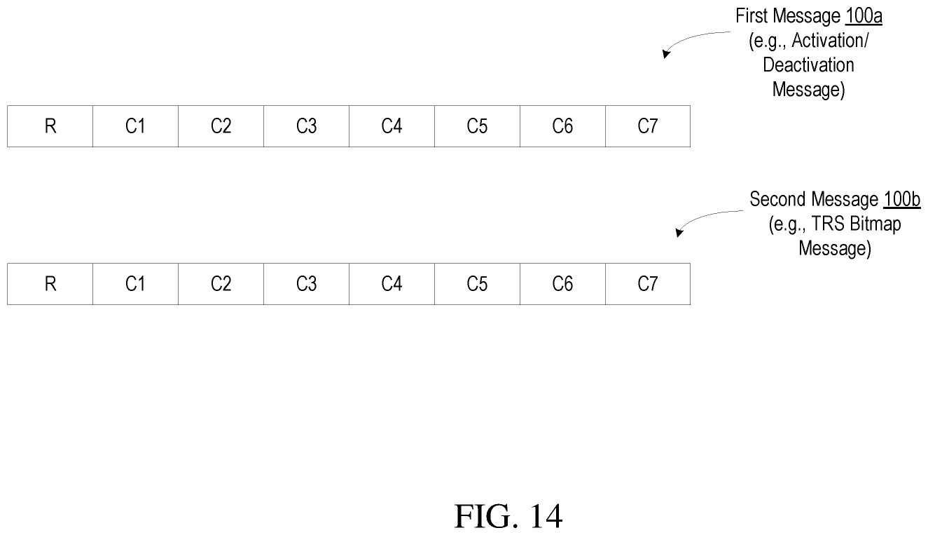

FIG. 14 shows an example of activation of SCells using an activation/deactivation message (i.e., first message 100a) and a TRS bitmap message (i.e., second message 100b). The activation/deactivation message can be a bitmap indicating the secondary cells that are activated/deactivated (e.g., SCell activation/deactivation MAC CE). The information about the secondary cells for which temporary RS is triggered may be found in the TRS bitmap message. For a secondary cell (e.g., a first cell C1 in FIG. 12), if the corresponding bit in the activation/deactivation message is set to 1, and the corresponding bit (e.g., for C1) in the TRS bitmap message is set to 1, the WD 22 can determine that TRS is present for that secondary cell (e.g., C1) during the activation process. The messages can be carried within a single MAC CE or more than one MAC CE, e.g., transmitted in the same PDSCH, in different PDSCHs, etc.

In another embodiments, sending temporary RS for one or more (e.g., less than all) secondary cells is described as follows. The WD 22 receives an activation command, e.g., a SCell activation command, indicating activation/deactivation of the secondary cells configured for the WD 22. The WD 22 determines a first set of secondary cells and are being activated. The WD 22 receives a bitmap (e.g., temporary RS bitmap or TRS bitmap), where each bit of the bitmap is associated with a secondary cell in the first set. If the bit for a secondary cell is set to a first value (e.g., 1), the temporary RS for the corresponding secondary cell is present. Otherwise, there is no temporary RS for the corresponding secondary cell, and the WD 22 follows a regular SCell activation timeline (e.g., not rely on temporary RS for activation). Thus, the WD 22 determines based on the bitmap whether temporary RS is present for a secondary cell being activated and follows the SCell activation procedure based on the temporary RS. Otherwise, the WD 22 follows the regular SCell activation procedure without assuming presence of the temporary RS.

The activation/deactivation command, e.g., SCell activation command, can be in a MAC CE. Another command with a bitmap (e.g., temporary RS bitmap or TRS bitmap)) can be in the same MAC CE (e.g., as the SCell activation/deactivation command), or in another MAC CE. The single MAC CE or the more than one MAC CE can be sent within the same PDSCH.

In a nonlimiting example, one bit in the MAC CE is used to indicate if the temporary RS is transmitted from a network node 16, e.g., a PSCell, regarding one or more SCells (e.g., relevant SCells). If the bit is set to 1, then the temporary RS is transmitted from the network node 16, e.g., the PCell, for the SCells that have temporary RS configured and are activated per the instruction in the MAC CE. In another nonlimiting example, if the bit is set to 1, then the temporary RS is transmitted from the network node 16 for the SCells that have temporary RS configured, are activated per the instruction in the MAC CE, and were not activated prior a reception of the MAC CE. In the MAC specification, the Reserved bit can be reused in the existing Activation/Deactivation MAC CEs, e.g., existing SCell Activation/Deactivation MAC CEs, which has the benefit that no new MAC CE format needs to be defined.

When CSI-RS for tracking is configured for a WD 22, RRC signaling is used to indicate the resource set information, the QCl information associated with resource set, the triggering offset associated with the resource set. In an embodiment, the command (e.g., MAC CE containing the TRS bitmap or MAC CE triggering the temporary RS) can also explicitly indicate whether the temporary RS is a pre-determined temporary reference signal (e.g., resource set ID/temporary RS used for activation is fixed by RRC), or whether additional temporary RS information is included explicitly within the command. For example, the WD 22 can receive a plurality of higher layer (e.g., RRC) configured temporary RS resource sets, and the command can indicate explicitly which temporary RS resource set is triggered from the plurality of the higher layer configured temporary RS resource sets.

In an embodiment, the QCL source for a temporary RS is explicitly indicated in the MAC CE, which allows, for example, flexibility at the network node 16 side to dynamically associate a single temporary RS resource set with different SSBs or different TCI States, based on an implementation, without having to configure many additional temporary reference signal resource sets.

In some embodiments, e.g., depending on SCell known/unknown cases, the WD 22 may use multiple bursts of temporary RS to perform additional functions such as AGC. Configuration changes of SCells occur less often than activation/deactivation. Therefore, for a configured network node 16 that is a secondary cell, the need for single burst versus multiple bursts may change depending on a plurality of conditions. Rather than RRC configuring multiple temporary RS resource sets and where each resource set is targeted towards different number of bursts, carrying the burst information within the MAC CE command is beneficial. For example, higher layers may configure burst lengths (e.g., in slots) of 1, 2, 4, etc., and the MAC CE indicates the burst length explicitly (e.g., by 2-bit index into the configured burst lengths).

An TRS may be considered as single burst occupying four OFDM symbols in two adjacent slots. In case of two bursts, the same TRS may occupy four OFDM symbols in a first set of two adjacent slots, and another four OFDM symbols in a second set of two adjacent slots, where the first and second sets may themselves be adjacent or separated by a configured duration. For example, in a two-bursts case, TRS may occupy four OFDM symbols in slots x and x+1, and four OFDM symbols in slots x+Offset, x+1+Offset, where the Offset may be configured by higher layer or indicated with the MAC CE itself. The same principle may apply for burst of longer durations.

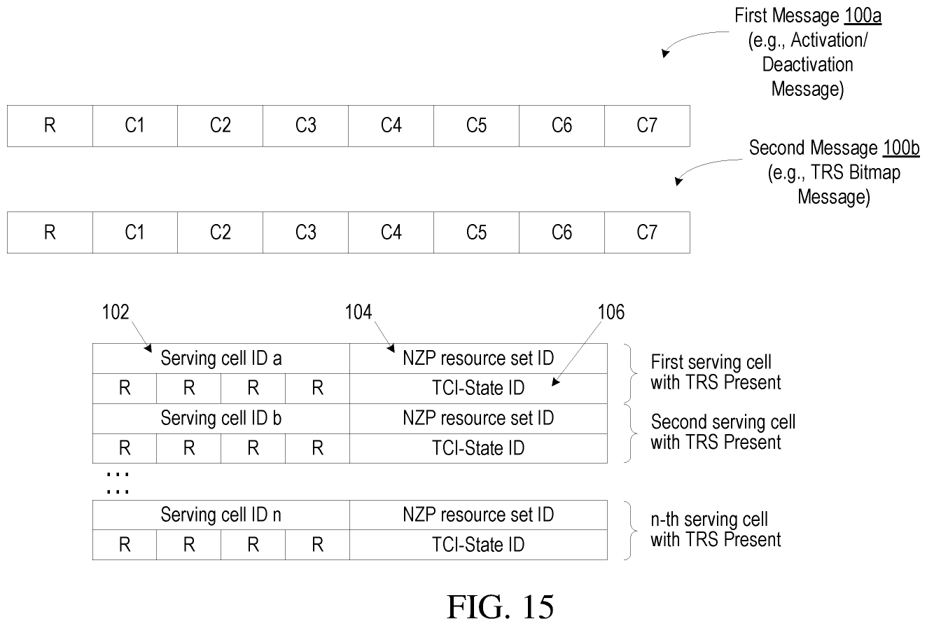

FIG. 15 shows an example of configurations where TRS is present. One or more serving cell IDs 102 (e.g., Serving cell IDs a, b, . . . , n), NSP resource set ID 104, and/or TCI-State ID 106 may be included in a message. More specifically, FIG. 15 shows an entire message that can be carried in a single MAC CE (e.g., including both a first message 100a such as an activation/deactivation message and a second message 100b such as a TRS-related message including TRS bitmap message, information regarding TRS that are present such as serving cell ID, NZP resource set ID, etc.). Two MAC CEs (e.g., one including an activation message, one including an TRS-related message) may be carried within same PDSCH. Similar to FIG. 14, the activation/deactivation message may be a bitmap indicating the secondary cells that are activated/deactivated. The information about the secondary cells for which temporary RS is triggered can be the TRS bitmap message. For a secondary cell (e.g., such as served by a network node 16), if the corresponding bit in the activation/deactivation message is set to 1, and the corresponding bit in the TRS bitmap message is set to 1, the WD 22 can determine that TRS is present for that secondary cell during the activation procedure. Then, additional information about the TRS present for the secondary cells can also be sent along with the message. For example, for the secondary cells that are being activated, and for which the TRS bitmap indicates that TRS is present during activation, additional information about the TRS can be provided such as the non-zero power CSI-RS resource set ID and associated TCI state identifier. R as shown denotes reserved bits. For example, if a network node 16, e.g., using a PCell, configures seven SCells, indicates that four SCells are being activated, and triggers TRS for two of the SCells, an example of a command may include the following:

R000, 1111 --- SCell activation/deactivation message
R000, 0011 --- TRS bitmap message

Cell ID6, NZP resource set ID X6, RRRR, TCI state ID Y6—information about TRS for each SCell being activated for which TRS is present

Cell ID7, NZP resource set ID X7, RRRR, TCI state ID Y6—information about TRS for each SCell being activated for which TRS is present

In some embodiments, NZP resource set and NZP-CSI-RS resource set are used interchangeably. In above example, the number of TCI state IDs that are needed may depend on the number of temporary RS resources that are in the NZP resource set. If the NZP resource set has only a single resource, then one TCI state ID is sufficient. But if the NZP resource set has multiple (e.g., N) temporary RS resources, then N TCI state IDs, e.g., one corresponding to each temporary RS resource may be used. In an embodiment, multiple TCI state IDs per NZP resource set ID are provided in the MAC CE. In some embodiments, the same TCI state ID can apply to all the N temporary RS resources in the NZP resource set. Providing one TCI-State ID per NZP resource set may be sufficient.

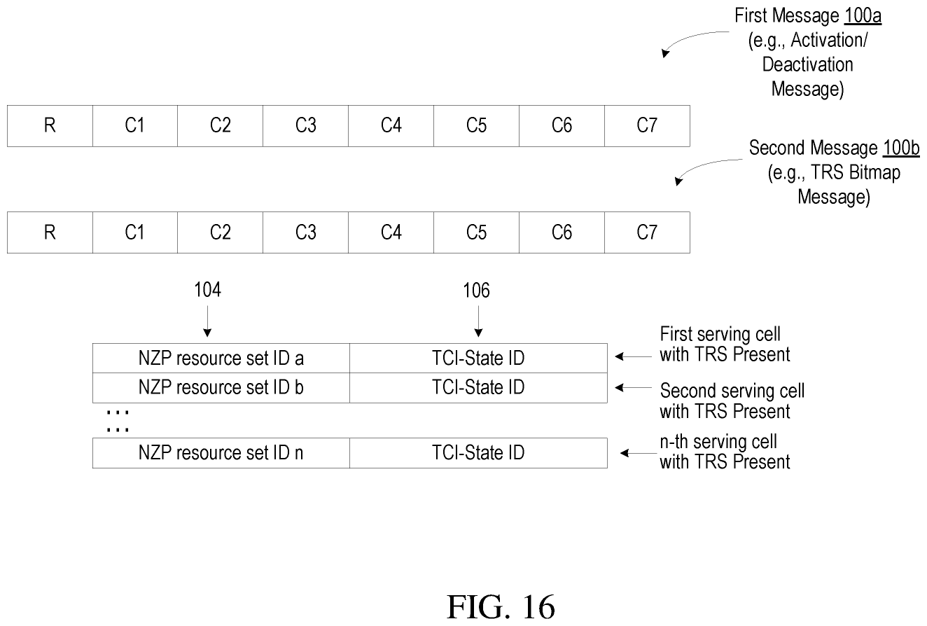

In some other embodiments, the signaling overhead due to serving cell ID may be reduced in the MAC CE, e.g., when maximum of only one NZP resource set ID 104 can be triggered/indicated per serving cell that is being activated. The serving cell ID 102 may be omitted from the message. This is shown in below FIG. 16, which may be compared with FIG. 15. The first NZP resource set (e.g., ID=a) of FIG. 16 belongs to the first SCell in the TRS bitmap message, such as the lowest serving cell ID, that is being activated and for which TRS is present during cell activation, e.g., SCell activation, and so on. One or more (e.g., all) messages can be carried within a single MAC CE or more than one MAC CE. In one embodiment, a legacy MAC CE may be used for activation/deactivation of cells and another MAC CE as described in the present disclosure, e.g., including a TRS bit map, NZP resource set, and TCI state indication and transmitted in the same PDSCH. Using the example of FIG. 15, a command may include the following:

R000, 1111 --- activation/deactivation message
R000, 0011 --- TRS bitmap message

NZP resource set ID c is for Cell #6, first TCI state ID—information about TRS for SCell #6

NZP resource set ID d is for Cell #7, second TCI state ID—information about TRS for SCell #7

The number of TCI state IDs that are needed may depend on the number of temporary RS resources that are in the NZP resource set. If the NZP resource set has only a single resource, then one TCI state ID is sufficient. But if the NZP resource set has multiple (e.g., N) temporary RS resources, then N TCI state IDs (e.g., one corresponding to each temporary RS resource may be needed). In an embodiment, multiple TCI state IDs per NZP resource set ID are provided in the MAC CE. In another embodiment, the same TCI state ID can apply to all the N temporary RS resources in the NZP resource set. Providing one TCI-State ID per NZP resource set may be sufficient. In another embodiment, instead of the Serving Cell ID, which is five bits long, the message can include a length field per serving cell, which may be smaller than 5 bits. A number of configurations per cell may be limited by how many bits are used for the “length” field.

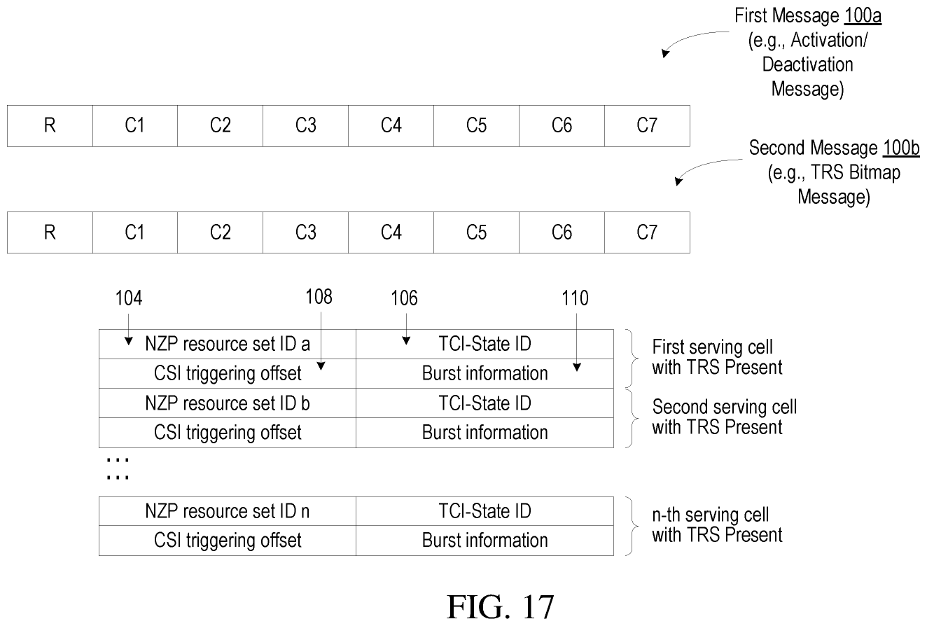

Additional information about the TRS present during activation for a SCell can also be included in the messages/command. For example, the CSI triggering offset and burst information can also be explicitly included in the message, as shown in FIG. 17. More specifically, a message may include one or more of NZP resource set ID 104 (e.g., NZP resource set ID a, b, . . . , n) and/or TCI-State ID 106 and/or CSI triggering offset 108 and/or burst information 110. One or more messages can be carried within a single MAC CE or more than one MAC CE that are transmitted, e.g., in the same PDSCH. The number of TCI state IDs that are used may depend on the number of temporary RS resources that are in the NZP resource set. If the NZP resource set has only a single resource, then one TCI state ID is sufficient. But if the NZP resource set has multiple (e.g., N) temporary RS resources, then N TCI state IDs (one corresponding to each temporary RS resource may be used).

In an embodiment, multiple TCI state IDs per NZP resource set ID are provided in the MAC CE. In another embodiment, the same TCI state ID can apply to all the N temporary RS resources in the NZP resource set. In this case, providing one TCI-State ID per NZP resource set can be sufficient. In some embodiments, a network node 16 transmits in a single MAC CE TRS activation for a SCell. The serving Cell ID associated with the SCell is present in the MAC CE. Upon receiving the MAC CE, the WD 22 determines that the temporary RS is triggered on the indicated serving Cell. In other words, in some embodiments, the TRS bit map may be omitted. In this MAC CE, multiple sets (e.g., NZP resource set, TCI-state ID, CSI triggering offset, and burst info) can be included, and one set of configuration may take a fixed number of bits, such as 2 octets.

### A-TRS Trigger State List

In some embodiments, a WD 22 configured with carrier aggregation (CA) operates by communicating using a PCell. In addition, the WD 22 may be configured with a first set of SCells. The WD 22 receives a first message indicating SCell activation for a second set of SCells. In response to the first message, the WD 22 initiates activation of the second set of SCells. The WD 22 may also receive a second message associated with tracking RS or TRS (e.g., alternatively referred to as ‘temporary RS’, ‘SCell activation RS’, CSI RS for tracking) for a third set of the second set of SCells. The TRS can be an aperiodic TRS (A-TRS). The first and second messages may be included in a single PDSCH received by the WD 22. The first message can be an activation MAC CE, such as a SCell activation MAC CE. The second message may be included in the same activation MAC CE. Alternately, the second message may be a separate MAC CE used for triggering TRS. The WD 22 uses the A-TRS to perform SCell activation with an adjusted activation delay.

The second message may include a trigger state index identifying a specific trigger state from a list of trigger states (e.g., A-TRS trigger state list). For example, if N trigger states are configured in the list the trigger state index could be indicated using ceil(log 2(N)) bits included in second message. As nonlimiting examples, N can be 64,128 or 256.

The list of trigger states can be configured for the WD 22 using a RRC layer message (e.g., a new RRC IE called CSI-AperiodicTRSTriggerStateList-r17). Each trigger state in the list of trigger states can be associated with one or more NZP CSI-RS resource sets and one or more TCI states providing quasi-colocation (QCL) source for each of the NZP CSI-RS resource sets. The list of trigger states in the A-TRS trigger state list may include trigger states that are associated with TRS (i.e., all NZP CSI-RS resource sets for all trigger states include the field trs-info or the WD 22 can implicitly assume trs-Info is true for any NZP CSI-RS resource set belonging to the trigger states).

The WD 22 may be configured with multiple A-TRS trigger state lists with each list corresponding to a particular serving cell (e.g., PCell, SCells in the first set of SCells). Each trigger state in the A-TRS trigger state list configured for a serving cell, e.g., a SCell, may trigger a TRS on one or more serving cells.

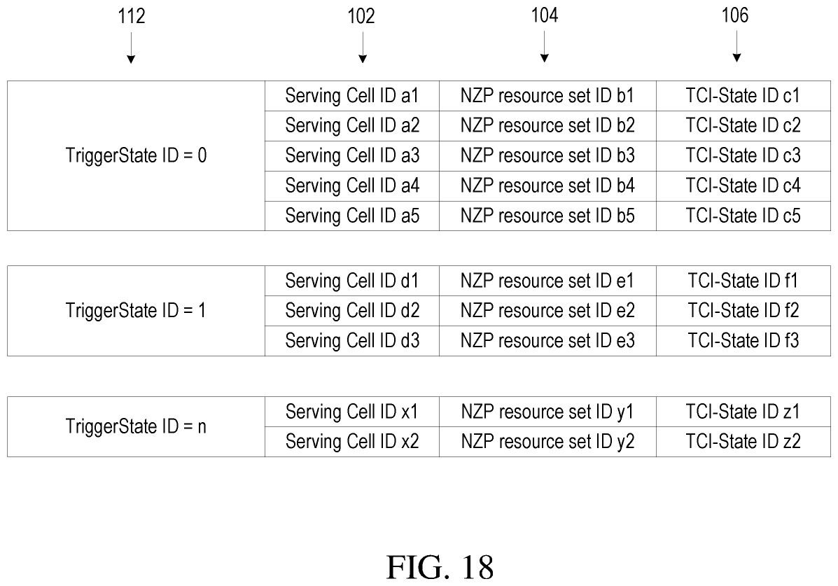

In some embodiments, a WD 22 supporting CA can be configured two SCells (e.g., SCell1 and SCell2) and with a A-TRS trigger state list as part of serving cell configuration of a PCell (e.g., as part of the CSI measurement configuration of the serving cell RRC configuration). A trigger state with index s1 in the list can correspond to A-TRS for SCell1 with TCI state index linked to SSBx1 of SCell1. A trigger state s2 can correspond to A-TRS for SCell2 with TCI state index linked to SSBy1 of SCell2. A trigger state s3 can correspond to A-TRS on SCell1 with TCI state index linked to SSBx1 of SCell1 and also A-TRS on SCell2 with TCI state index linked to SSBy1 of SCell2, trigger s4 can correspond to A-TRS for SCell1 with TCI state index linked to SSBx2 of SCell1, and so on. An example of the configuration described above is shown in FIG. 18. More specifically, FIG. 18 shows example configurations grouped by trigger ID 112, each one including one or more serving cell IDs 102 and/or NZP resource set IDs 104 and/or TCI-State IDs 106. A number of TCI state IDs that are used may depend on the number of temporary RS resources that are in the NZP resource set. If the NZP resource set has only a single resource, then one TCI state ID is sufficient. But if the NZP resource set has multiple (e.g., N) temporary RS resources, then N TCI state IDs (e.g., one corresponding to each temporary RS resource may be needed).

In some embodiments, multiple TCI state IDs per NZP resource set ID are provided in the MAC CE. In some other embodiments, the same TCI state ID can apply to all the N temporary RS resources in the NZP resource set. Providing one TCI-State ID per NZP resource set can be sufficient.

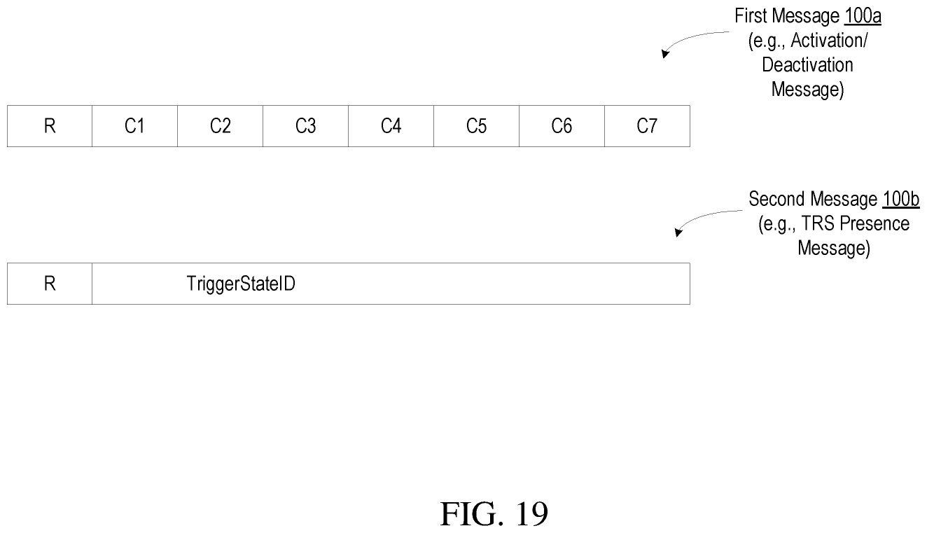

FIG. 19 shows another example of a message (e.g., MAC CE message) using a trigger state list for activating at least a SCell. The first row indicates the cells that are activated/deactivated. The TRS presence message includes the trigger state ID, and based on the trigger state ID, the WD 22 can determine whether TRS is present for each serving cell, e.g., SCell, and that is being activated. If the trigger state ID includes NZP resource set ID for a cell that is deactivated or not activated, the WD 22 can simply ignore the corresponding information for the deactivated cell.

In an embodiment, as part of serving cell configuration of a serving cell (e.g., PCell), the WD 22 can be configured with one or more A-TRS trigger state lists with each list corresponding to a SCell of the first set of SCells. For example, the WD 22 can be configured with first set of trigger states (e.g., with trigger indexes x1,x2,x3, . . . ) for a first SCell (e.g., SCellx) of the first set. A second set of trigger states (e.g., with trigger state indexes y1,y2,y3, . . . ) for a second SCell (e.g., SCelly) of the first set, and third set of trigger states (e.g., with trigger state indexes z1,z2,z3, . . . ) for a third SCell (e.g., SCellz) of the first set.

The second message may include multiple trigger state indices (i.e., indices) with each index corresponding a SCell of first set. In the example described above, if the first message indicates that SCellx and Scellz are activated (i.e., SCellx and SCellz are the second set of SCells), then the second message can include a trigger state corresponding SCellx (i.e., one of x1,x,2,x3) and a trigger state corresponding to SCellz (i.e., one of z1,z2,z3). The trigger state indices can be included by following ascending order of cell index of the activated SCells. One of the trigger states, such as 0, can be reserved to indicate absence of A-TRS.

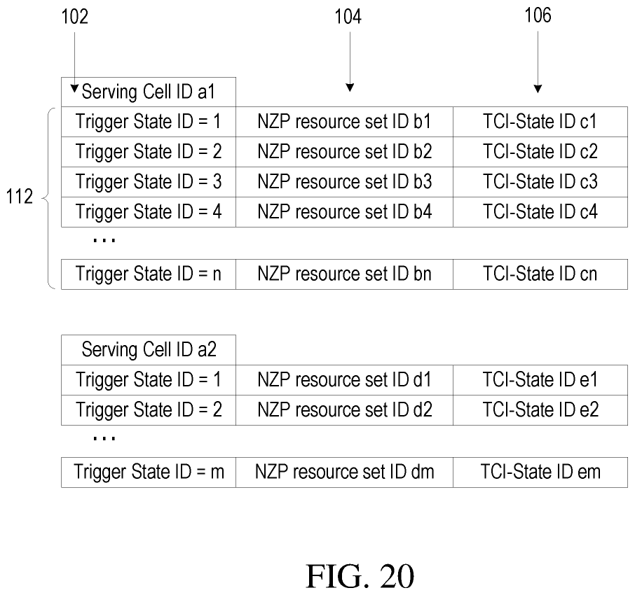

FIG. 20 shows an example configuration including one or more serving cell IDs 102, each serving cell ID 102 being associated with one or more of trigger state IDs 112 and/or NZP resource set IDs 104 and/or TCI-State IDs 106. More specifically, the configuration includes a serving cell with serving cell ID a1 having n trigger states, and another serving cell with ID a2 having m trigger states. The number of TCI state IDs that are used may depend on the number of temporary RS resources that are in the NZP resource set. If the NZP resource set has only a single resource, then one TCI state ID is sufficient. But, if the NZP resource set has multiple (e.g., N) temporary RS resources, then N TCI state IDs (one corresponding to each temporary RS resource may be needed. In one embodiment, multiple TCI state IDs per NZP resource set ID are provided in the MAC CE. In another embodiment, the same TCI state ID can apply to all the N temporary RS resources in the NZP resource set. Providing one TCI-State ID per NZP resource set can be sufficient.

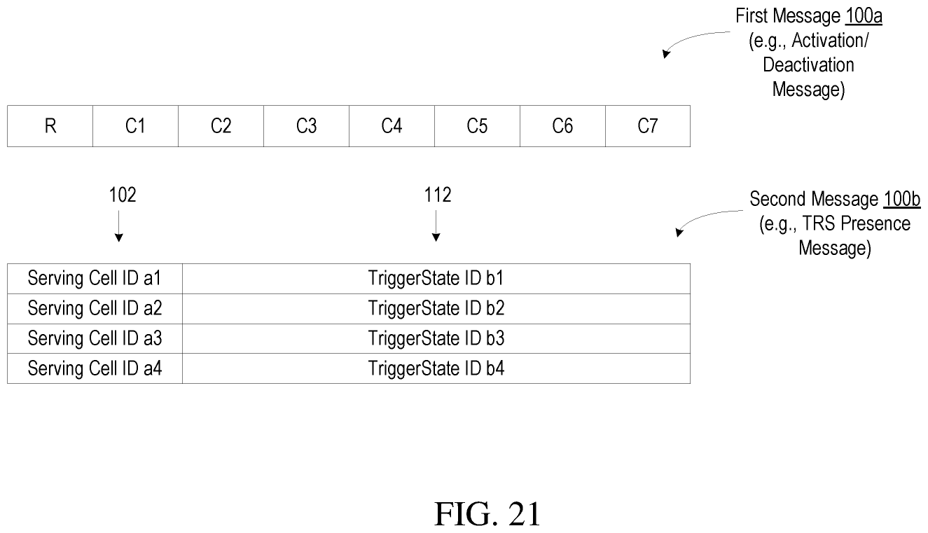

FIG. 21 shows another MAC CE using a trigger state list for activating a SCell. The first message 100a indicates the cells that are activated/deactivated. The second message 100b may include serving cell ID 112 and/or trigger state ID 102. For example, the second message 100b (e.g., TRS presence message) may include the trigger state ID 102 for each serving cell being activated, for which network node 16, e.g., using a PCell, is configured to (e.g., intends to) send TRS for SCell activation (e.g., fast SCell activation).

A WD 22 may also be configured with a separate trigger state list that includes trigger states that are associated with multiple types of CSI RS including TRS, zero-power (ZP) or non-zero power (NZP) CSI RS resources for interference measurements (CSI-IM), or NZP CSI-RS resource for channel measurements. Configuring separate trigger state lists where one list corresponds to trigger states of the reference signals used for reducing latency for SCell activation and another list corresponding to trigger states of multiple types of CSI-RS (e.g., the existing CSI-AperiodicTriggerStateList), based on which WD 22 reports, provides more flexibility for triggering the reference signals used during SCell activation. A nonlimiting example of SCell activation includes using a list with only TRS or temporary RS or SCell activation RS triggers. A nonlimiting example of WD reports include CQI/PMI/RI/RSRP.

Trigger states in the A-TRS trigger state list may also be associated with a parameter that indicates a number of slots (or a number of bursts with each burst being one or two slots) in which the A-TRS is transmitted. Trigger states in the A-TRS trigger state list may also be associated with a parameter that indicates a slot offset. For example, if the WD 22 detects the second message and transmits HARQ-ACK corresponding to the PDSCH carrying the second message in slot n, and slot offset is X slots, the WD 22 can assume that A-TRS is triggered in first slot after slot n+X+3*3Nₛₗₒₜ^{subframe,μ} where μ corresponds to the to the sub-carrier spacing used for PUCCH transmission carrying the HARQ-ACK.

### Fast SCell Activation Based on Common Beam Operation

A fast SCell activation process (i.e., cell activation process) which may rely on common beam operation (e.g., using unified TCI states or common TCI states introduced in NR Rel-17) is described.

A common/unified DL TCI state used to receive PDSCH/PDCCH and other reference signals is updated in a PCell (e.g., in a network node 16 using the PCell) via a combination of RRC, MAC CE, and DCI. For example, a list of common/unified DL TCI states are RRC configured, a subset of the RRC configured common/unified DL TCI states are activated by MAC CE, and one among the common/unified DL TCI state activated by the MAC CE is updated via DL DCI. If the PCell and the SCell(s) belong to the same band, the same beam (and/or unified/common DL TCI state) may be used to receive the DL channels/reference signals in the PCell and the SCell(s) in a common beam operation. Hence, in this embodiment, the updated common/unified DL TCI state in the PCell may also be applicable to at least an Scell in the same band. When an activation command, e.g., a SCell Activation command, is sent to activate a SCell via MAC CE, the TCI state ID does not have to be indicated in the MAC CE. The activation command, e.g., the SCell Activation command MAC CE, can include information related to the temporary RS (e.g., excluding TCI state information associated with the temporary RS) using any one of the embodiments described above. When receiving the temporary RS for activating an Scell, the WD 22 uses the QCL source included in the updated common/unified DL TCI state in the PCell as the QCL source of the temporary RS.

The common/unified joint TCI state which is used to receive PDSCH/PDCCH/PUSCH/PUCCH and other reference signals is updated in the PCell via a combination of RRC, MAC CE and DCI (i.e., a list of common/unified joint TCI states are RRC configured, a subset of the RRC configured common/unified joint TCI states are activated by MAC CE, and one among the common/unified joint TCI state activated by the MAC CE is updated via DL DCI). If the PCell and the SCell(s) belong to the same band, the same beam (or unified/common joint TCI state) may be used to receive the DL and UL channels/reference signals in the PCell and the SCell(s) in common beam operation. Hence, in this embodiment, the updated common/unified joint TCI state in the PCell may also be applicable to an Scell in the same band. When the activation command, e.g., the SCell Activation command, is sent to activate an SCell via MAC CE, the TCI state ID does not have to be indicated in the MAC CE. The activation command, e.g., the SCell Activation command MAC CE, can include information related to the temporary RS (e.g., excluding TCI state information associated with the temporary RS) using any one of the embodiments above. When receiving the temporary RS for activating an Scell, the WD 22 uses the QCL source included in the updated common/unified joint TCI state in the PCell as the QCL source of the temporary RS.

The following is a nonlimiting list of example embodiments:
Embodiment A1. A first network node configured to communicate at least with a second network node and a wireless device (WD), the first network node configured to, and/or comprising a radio interface and/or comprising processing circuitry configured to:
transmit a first message including a bitmap structure indicating presence information of at least a reference signal for an activation of at least the second network node;
transmit a second message including trigger state information associated with at least the reference signal: and
receive a report from the WD indicating that the activation of at least the second network node is complete.
Embodiment A2. The first network node of Embodiment A1, wherein the trigger state information includes a trigger state identification indicating a trigger state in a first list of trigger states, each trigger state of the first list of trigger states being associated with at least a first resource set to be used as the reference signal, the first list of trigger states being preconfigured on the WD, the first resource set being a NZP-CSI RS resource set for one of a Channel State Information Reference Signal (CSI-RS) tracking and an Aperiodic Tracking Reference Signal (A-TRS).
Embodiment A3. The first network node of Embodiment A2, wherein the first list is a separate list from a second list of trigger states, each trigger state of the second list being associated with a second resource set for a CSI-RS, the CSI-RS being used for any one of an aperiodic CSI report, an RSRP report, interference measurements and tracking, the aperiodic CSI report corresponding to at least to another trigger state identification including bits in a Physical Downlink Control Channel Downlink Control Information (PDCCH DCI) format used for an aperiodic CSI request.
Embodiment A4. The first network node of any one of Embodiments A1-A3, wherein the second message further indicates any one of:
a cell identification, a Transmission Configuration Indication (TCI) state identification, and an NZP recourse set identification corresponding to the second network node;
the Transmission Configuration Indication (TCI) state identification and the NZP recourse set identification corresponding to the second network node; and
the Transmission Configuration Indication (TCI) state identification, the NZP resource set identification corresponding to the second network node, CSI triggering offset, and burst information.
Embodiment A5. The first network node of Embodiment A4, wherein the trigger state identification corresponds at least to the cell identification, the NZP resource set identification and the TCI state identification.
Embodiment A6. The first network node of Embodiment A4, wherein the cell identification is part of a plurality cell identifications, each cell identification of the plurality of cell identifications corresponding to any one of one NZP resource set identification and once TCI state identification.
Embodiment A7. The first network node of any one of Embodiments A1-A6, wherein a plurality of TCI state identifications corresponds to at least one NZP resource set identification of a plurality of NZP resource sets.
Embodiment A8. The first network node of any one of Embodiments A1-A7, wherein the first network node is Primary Cell (PCell) and the second network node is Secondary Cell (SCell).
Embodiment A9. The first network node of any one of Embodiments A1-A8, wherein the reference signal is a temporary reference signal, the temporary reference signal being a tracking reference signal (TRS)
Embodiment A10. The first network node of any one of Embodiments A1-A9, wherein each bit of the bitmap structure included in the first message indicates any one of another reserve bit, the reference signal for the activation of the second network node, and another reference signal for another activation of another network node.
Embodiment A11. The first network node of any one of Embodiments A1-A10, wherein the first network node and/or the radio interface and/or the processing circuitry is further configured to:
transmit an activation command, the activation command being another bitmap structure, each bit of the other bitmap structure indicating any one of a reserve bit, an activation, and a deactivation associated with a group of network nodes;
   one of cause the WD to determine a subgroup of the group of network nodes and transmit a third message indicating the subgroup, the second network node being part of the subgroup; and
   cause the WD to initiate the activation of at least of the second network node based at least on the second message.
Embodiment A12. The first network node of Embodiment A11, wherein the first network node and/or the radio interface and/or the processing circuitry is further configured to:
   cause the WD to determine that at least the reference signal corresponds to the activation of at least the second network node based at least on the activation command and the first message.
Embodiment A13. The first network node of Embodiment A11, wherein any one of the first message, the second message, and the activation command is received in a Medium Access Control (MAC) Control Element (CE).
Embodiment A14. The first network node of any one of Embodiments A1-A13, wherein receiving the report from the WD includes receiving a completion CSI report for the at least the second network node.
Embodiment A15. The first network node of any one of Embodiments A1-A14, wherein indicating that the activation of at least the second network node is complete includes a completion indication of an activation of more network nodes than a total number of reference signals indicated by the bitmap structure of the first message.
Embodiment A16. The first network node of any one of Embodiments A1-A15, wherein the first message explicitly indicates that the at least reference signal is predetermined.
Embodiment A17. The first network node of any one of Embodiments A1-A16, wherein a Quasi Co-Located (QCL) source for the at least reference signal is explicitly indicated at least in the second message.
Embodiment A18. The first network node of any one of Embodiments A1-A17, wherein the first network node and/or the radio interface and/or the processing circuitry is further configured to:
transmit a plurality of bursts of reference signals to cause the WD to perform Automatic Gain Control (AGC).
Embodiment A19. The first network node of any one of Embodiments A1-A18, wherein the first network node and the second network node operate using a same beam based on a unified Transmission Configuration Indication (TCI) state for one of a downlink and an uplink transmission.
Embodiment B1. A method implemented in a network node configured to communicate at least with a second network node and a wireless device (WD), the method comprising:
transmitting a first message including a bitmap structure indicating presence information of at least a reference signal for an activation of at least the second network node;
transmitting a second message including trigger state information associated with at least the reference signal; and
receiving a report from the WD indicating that the activation of at least the second network node is complete.
Embodiment B2. The method of Embodiment B1, wherein the trigger state information includes a trigger state identification indicating a trigger state in a first list of trigger states, each trigger state of the first list of trigger states being associated with at least a first resource set to be used as the reference signal, the first list of trigger states being preconfigured on the WD, the first resource set being a NZP-CSI RS resource set for one of a Channel State Information Reference Signal (CSI-RS) tracking and an Aperiodic Tracking Reference Signal (A-TRS).
Embodiment B3. The method of Embodiment B2, wherein the first list is a separate list from a second list of trigger states, each trigger state of the second list being associated with a second resource set for a CSI-RS, the CSI-RS being used for any one of an aperiodic CSI report, an RSRP report, interference measurements and tracking, the aperiodic CSI report corresponding to at least to another trigger state identification including bits in a Physical Downlink Control Channel Downlink Control Information (PDCCH DCI) format used for an aperiodic CSI request.
Embodiment B4. The method of any one of Embodiments B1-B3, wherein the second message further indicates any one of:
a cell identification, a Transmission Configuration Indication (TCI) state identification, and an NZP recourse set identification corresponding to the second network node;
the Transmission Configuration Indication (TCI) state identification and the NZP recourse set identification corresponding to the second network node; and
the Transmission Configuration Indication (TCI) state identification, the NZP resource set identification corresponding to the second network node, CSI triggering offset, and burst information.
Embodiment B5. The method of Embodiment B4, wherein the trigger state identification corresponds at least to the cell identification, the NZP resource set identification and the TCI state identification.
Embodiment B6. The method of Embodiment B4, wherein the cell identification is part of a plurality cell identifications, each cell identification of the plurality of cell identifications corresponding to any one of one NZP resource set identification and once TCI state identification.
Embodiment B7. The method of any one of Embodiments B1-B6, wherein a plurality of TCI state identifications corresponds to at least one NZP resource set identification of a plurality of NZP resource sets.
Embodiment B8. The method of any one of Embodiments B1-B7, wherein the first network node is Primary Cell (PCell) and the second network node is
Embodiment B9. The method of any one of Embodiments B1-B8, wherein the reference signal is a temporary reference signal, the temporary reference signal being a tracking reference signal (TRS)
Embodiment B10. The method of any one of Embodiments B1-B9, wherein each bit of the bitmap structure included in the first message indicates any one of another reserve bit, the reference signal for the activation of the second network node, and another reference signal for another activation of another network node.
Embodiment B11. The method of any one of Embodiments B1-B10, the method further including:
   transmitting an activation command, the activation command being another bitmap structure, each bit of the other bitmap structure indicating any one of a reserve bit, an activation, and a deactivation associated with a group of network nodes;
   one of causing the WD to determine a subgroup of the group of network nodes and transmitting a third message indicating the subgroup, the second network node being part of the subgroup; and
   causing the WD to initiate the activation of at least of the second network node based at least on the second message.
Embodiment B12. The method of Embodiment B11, the method further including:
   causing the WD to determine that at least the reference signal corresponds to the activation of at least the second network node based at least on the activation command and the first message.
Embodiment B13. The method of Embodiment B11, wherein any one of the first message, the second message, and the activation command is received in a Medium Access Control (MAC) Control Element (CE).
Embodiment B14. The method of any one of Embodiments B1-B13, wherein receiving the report from the WD includes receiving a completion CSI report for the at least the second network node.
Embodiment B15. The method of any one of Embodiments B1-B14, wherein indicating that the activation of at least the second network node is complete includes a completion indication of an activation of more network nodes than a total number of reference signals indicated by the bitmap structure of the first message.
Embodiment B16. The method of any one of Embodiments B1-B15, wherein the first message explicitly indicates that the at least reference signal is predetermined.
Embodiment B17. The method of any one of Embodiments B1-B16, wherein a Quasi Co-Located (QCL) source for the at least reference signal is explicitly indicated at least in the second message.
Embodiment B18. The method node of any one of Embodiments B1-B17, the method further includes:
transmitting a plurality of bursts of reference signals to cause the WD to perform Automatic Gain Control (AGC).
Embodiment B19. The method of any one of Embodiments B1-B18, wherein the first network node and the second network node operate using a same beam based on a unified Transmission Configuration Indication (TCI) state for one of a downlink and an uplink transmission.
Embodiment C1. A wireless device (WD) configured to communicate at least with a first network node and a second network node, the WD configured to, and/or comprising a radio interface and/or processing circuitry configured to:
receive a first message from the first network node including a bitmap structure indicating presence information of at least a reference signal for an activation of at least the second network node:
receive a second message from the first network node including trigger state information associated with at least the reference signal; and
complete the activation of at least the second network node based at least in part on the first message and the second message.
Embodiment C2. The WD of Embodiment C1, wherein the trigger state information includes a trigger state identification indicating a trigger state in a first list of trigger states, each trigger state of the first list of trigger states being associated with at least a first resource set to be used as the reference signal, the first list of trigger states being preconfigured on the WD, the first resource set being a NZP-CSI RS resource set for one of a Channel State Information Reference Signal (CSI-RS) tracking and an Aperiodic Tracking Reference Signal (A-TRS).
Embodiment C3. The WD of Embodiment C2, wherein the first list is a separate list from a second list of trigger states, each trigger state of the second list being associated with a second resource set for a CSI-RS, the CSI-RS being used for any one of an aperiodic CSI report, an RSRP report, interference measurements and tracking, the aperiodic CSI report corresponding to at least to another trigger state identification including bits in a Physical Downlink Control Channel Downlink Control Information (PDCCH DCI) format used for an aperiodic CSI request.
Embodiment C4. The WD of any one of Embodiments C1-C3, wherein the second message further indicates any one of:
a cell identification, a Transmission Configuration Indication (TCI) state identification, and an NZP recourse set identification corresponding to the second network node;
the Transmission Configuration Indication (TCI) state identification and the NZP recourse set identification corresponding to the second network node; and
the Transmission Configuration Indication (TCI) state identification, the NZP resource set identification corresponding to the second network node, CSI triggering offset, and burst information.
Embodiment C5. The WD of Embodiment C4, wherein the trigger state identification corresponds at least to the cell identification, the NZP resource set identification and the TCI state identification.
Embodiment C6. The WD of Embodiment C4, wherein the cell identification is part of a plurality cell identifications, each cell identification of the plurality of cell identifications corresponding to any one of one NZP resource set identification and once TCI state identification.
Embodiment C7. The WD of any one of Embodiments C1-C6, wherein a plurality of TCI state identifications corresponds to at least one NZP resource set identification of a plurality of NZP resource sets.
Embodiment C8. The WD of any one of Embodiments C1-C7, wherein the first network node is Primary Cell (PCell) and the second network node is Secondary Cell (SCell).
Embodiment C9. The WD of any one of Embodiments C1-C8, wherein the reference signal is a temporary reference signal, the temporary reference signal being a tracking reference signal (TRS)
Embodiment C10. The WD of any one of Embodiments C1-C9, wherein each bit of the bitmap structure included in the first message indicates any one of another reserve bit, the reference signal for the activation of the second network node, and another reference signal for another activation of another network node.
Embodiment C11. The WD of any one of Embodiments C1-C10, wherein the WD and/or the radio interface and/or the processing circuitry is further configured to:
receive an activation command, the activation command being another bitmap structure, each bit of the other bitmap structure indicating any one of a reserve bit, an activation, and a deactivation associated with a group of network nodes;
one of determine a subgroup of the group of network nodes and receive a third message indicating the subgroup, the second network node being part of the subgroup; and
initiate the activation of at least of the second network node based at least on the second message.
Embodiment C12. The WD of Embodiment C11, wherein the WD and/or the radio interface and/or the processing circuitry is further configured to:
   determine that at least the reference signal corresponds to the activation of at least the second network node based at least on the activation command and the first message.
Embodiment C13. The WD of Embodiment C11, wherein any one of the first message, the second message, and the activation command is received in a Medium Access Control (MAC) Control Element (CE).
Embodiment C14. The WD of any one of Embodiments C1-C13, wherein completing the activation of at least the second network node includes transmitting a completion CSI report for the at least the second network node.
Embodiment C15. The WD of any one of Embodiments C1-C14, wherein completing the activation of at least the second network node includes a completion of an activation of more network nodes than a total number of reference signals indicated by the bitmap structure of the first message.
Embodiment C16. The WD of any one of Embodiments C1-C15, wherein the first message explicitly indicates that the at least reference signal is predetermined.
Embodiment C17. The WD of any one of Embodiments C1-C16, wherein a Quasi Co-Located (QCL) source for the at least reference signal is explicitly indicated at least in the second message.
Embodiment C18. The WD of any one of Embodiments C1-C17, wherein the WD and/or the radio interface and/or the processing circuitry is further configured to:
receive a plurality of bursts of reference signals to perform Automatic Gain Control (AGC).
Embodiment C19. The WD of any one of Embodiments C1-C18, wherein the first network node and the second network node operate using a same beam based on a unified Transmission Configuration Indication (TCI) state for one of a downlink and an uplink transmission.
Embodiment D1. A method implemented in a wireless device (WD) configured to communicate at least with a first network node and a second network node, the method comprising:
receiving a first message from the first network node including a bitmap structure indicating presence information of at least a reference signal for an activation of at least the second network node:
receiving a second message from the first network node including trigger state information associated with at least the reference signal; and
completing the activation of at least the second network node based at least in part on the first message and the second message.
Embodiment D2. The method of Embodiment D1, wherein the trigger state information includes a trigger state identification indicating a trigger state in a first list of trigger states, each trigger state of the first list of trigger states being associated with at least a first resource set to be used as the reference signal, the first list of trigger states being preconfigured on the WD, the first resource set being a NZP-CSI RS resource set for one of a Channel State Information Reference Signal (CSI-RS) tracking and an Aperiodic Tracking Reference Signal (A-TRS).
Embodiment D3. The method of Embodiment D2, wherein the first list is a separate list from a second list of trigger states, each trigger state of the second list being associated with a second resource set for a CSI-RS, the CSI-RS being used for any one of an aperiodic CSI report, an RSRP report, interference measurements and tracking, the aperiodic CSI report corresponding to at least to another trigger state identification including bits in a Physical Downlink Control Channel Downlink Control Information (PDCCH DCI) format used for an aperiodic CSI request.
Embodiment D4. The method of any one of Embodiments D1-D3, wherein the second message further indicates any one of:
a cell identification, a Transmission Configuration Indication (TCI) state identification, and an NZP recourse set identification corresponding to the second network node:
the Transmission Configuration Indication (TCI) state identification and the NZP recourse set identification corresponding to the second network node: and
the Transmission Configuration Indication (TCI) state identification, the NZP resource set identification corresponding to the second network node, CSI triggering offset, and burst information.
Embodiment D5. The method of Embodiment D4, wherein the trigger state identification corresponds at least to the cell identification, the NZP resource set identification and the TCI state identification.
Embodiment D6. The method of Embodiment D4, wherein the cell identification is part of a plurality cell identifications, each cell identification of the plurality of cell identifications corresponding to any one of one NZP resource set identification and once TCI state identification.
Embodiment D7. The method of any one of Embodiments D1-D6, wherein a plurality of TCI state identifications corresponds to at least one NZP resource set identification of a plurality of NZP resource sets.
Embodiment D8. The method of any one of Embodiments D1-D7, wherein the first network node is Primary Cell (PCell) and the second network node is
Embodiment D9. The method of any one of Embodiments D1-D8, wherein the reference signal is a temporary reference signal, the temporary reference signal being a tracking reference signal (TRS)
Embodiment D10. The method of any one of Embodiments D1-D9, wherein each bit of the bitmap structure included in the first message indicates any one of another reserve bit, the reference signal for the activation of the second network node, and another reference signal for another activation of another network node.
Embodiment D11. The method of any one of Embodiments D1-D10, the method further including:
receiving an activation command, the activation command being another bitmap structure, each bit of the other bitmap structure indicating any one of a reserve bit, an activation, and a deactivation associated with a group of network nodes;
one of determining a subgroup of the group of network nodes and receiving a third message indicating the subgroup, the second network node being part of the subgroup; and
initiating the activation of at least of the second network node based at least on the second message.
Embodiment D12. The method of Embodiment D11, the method further including:
determining that at least the reference signal corresponds to the activation of at least the second network node based at least on the activation command and the first message.
Embodiment D13. The method of Embodiment D11, wherein any one of the first message, the second message, and the activation command is received in a Medium Access Control (MAC) Control Element (CE).
Embodiment D14. The method of any one of Embodiments D1-D13, wherein completing the activation of at least the second network node includes transmitting a completion CSI report for the at least the second network node.
Embodiment D15. The method of any one of Embodiments D1-D14, wherein completing the activation of at least the second network node includes a completion of an activation of more network nodes than a total number of reference signals indicated by the bitmap structure of the first message.
Embodiment D16. The method of any one of Embodiments D1-D15, wherein the first message explicitly indicates that the at least reference signal is predetermined.
Embodiment D17. The method of any one of Embodiments D1-D16, wherein a Quasi Co-Located (QCL) source for the at least reference signal is explicitly indicated at least in the second message.
Embodiment D18. The method of any one of Embodiments D1-D17, the method further including:
receiving a plurality of bursts of reference signals to perform Automatic Gain Control (AGC).
Embodiment D19. The method of any one of Embodiments D1-D18, wherein the first network node and the second network node operate using a same beam based on a unified Transmission Configuration Indication (TCI) state for one of a downlink and an uplink transmission.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising processing circuitry and a radio interface in communication with the processing circuitry:
the processing circuitry being configured to:
determine a reference signal presence message including presence information of at least one reference signal for an activation of at least one secondary cell, the presence information including at least one index indicating a trigger state from a trigger state list; and
the radio interface being configured to:
transmit the reference signal presence message; and
receive a report from the WD indicating that the activation of at least one secondary cell using the at least one reference signal is complete.

2. The network node of claim 1, wherein at least one of:
the WD is configured with a first set of secondary cells; and
the radio interface is further configured to:
transmit an activation message indicating at least a secondary cell activation of a second set of secondary cells, the at least one reference signal, the transmitted reference signal message, and the transmitted activation message being usable by the WD, in part, to activate the at least one secondary cell.

3. The network node of claim 2, wherein each index of the at least one index corresponds to one secondary cell of the first set of secondary cells.

4. The network node of claim 1, wherein each trigger state of the trigger state list is associated with at least one non-zero power channel state information reference signal, NZP CSI RS, resource set.

5. The network node of claim 4, wherein each trigger state of the trigger state list is associated with at least one transmission configuration information, TCI, state providing a quasi-location source at least for one corresponding NZP resource set.

6. The network node of claim 5, wherein the at least one TCI state is indicated by a TCI state identifier.

7. The network node of claim 1, wherein at least one trigger state of the trigger state list triggers one reference signal on at least one cell.

8. The network node of claim 1, wherein the trigger state list includes a first trigger state list and a second trigger state list, the first trigger state list corresponding to at least one trigger state associated with latency of the activation of the at least one secondary cell, the second trigger state list corresponding to at least one type of channel state information reference signal, CSI RS.

9. The network node of claim 1, wherein the at least one reference signal is a tracking reference signal, TRS, and the report is a completion channel state information reference signal, CSI, report.

10. The network node of claim 1, wherein the network node is configured to communicate with the WD using at least a primary cell.

11. A method in a network node configured to communicate with a wireless device, WD, the method comprising:
determining a reference signal presence message including presence information of at least one reference signal for an activation of at least one secondary cell, the presence information including at least one index indicating a trigger state from a trigger state list;
transmitting the reference signal presence message; and
receiving a report from the WD indicating that the activation of at least one secondary cell using the at least one reference signal is complete.

12.-20. (canceled)

21. A wireless device, WD, configured to communicate at least with a network node, the WD comprising processing circuitry and a radio interface in communication with the processing circuitry:
the radio interface being configured to:
receive a reference signal presence message including presence information of at least one reference signal for an activation of at least one secondary cell, the presence information including at least one index indicating a trigger state from a trigger state list; and
receive the at least one reference signal; and
the processing circuitry being configured to:
complete the activation of the at least one secondary cell based at least in part on the received reference signal presence message and the received at least one reference signal.

22. The WD of claim 21, wherein at least one of:
the WD is configured with a first set of secondary cells; and
the radio interface is further configured to:
receive an activation message indicating at least a secondary cell activation of a second set of secondary cells, completing the activation of the at least one secondary cell being further based on the activation message.

23. The WD of claim 22, wherein each index of the at least one index corresponds to one secondary cell of the first set of secondary cells.

24. The WD of claim 21, wherein each trigger state of the trigger state list is associated with at least one non-zero power channel state information reference signal, NZP CSI RS, resource set.

25. The WD of claim 24, wherein each trigger state of the trigger state list is associated with at least one transmission configuration information, TCI, state providing a quasi-location source at least for one corresponding NZP resource set.

26. The WD of claim 25, wherein the at least one TCI state is indicated by a TCI state identifier.

27. The WD of claim 21, wherein at least one trigger state of the trigger state list triggers one reference signal on at least one cell.

28. The WD of claim 21, wherein the trigger state list includes a first trigger state list and a second trigger state list, the first trigger state list corresponding to at least one trigger state associated with latency of the activation of the at least one secondary cell, the second trigger state list corresponding to at least one type of channel state information reference signal, CSI RS.

29. The WD claim 21, wherein the at least one reference signal is a tracking reference signal, TRS, and completing the activation of the at least one secondary cell includes causing the radio interface to transmit a report indicating that the activation of at least one secondary cell using the at least one reference signal is complete, the report being a completion channel state information reference signal, CSI, report.

30. The WD of claim 21, wherein the WD is configured to communicate with the network node using at least a primary cell.

31. A method in a wireless device, WD, configured to communicate at least with a network node, the method comprising:
receiving a reference signal presence message including presence information of at least one reference signal for an activation of at least one secondary cell, the presence information including at least one index indicating a trigger state from a trigger state list;
receiving the at least one reference signal; and
completing the activation of the at least one secondary cell based at least in part on the received reference signal presence message and the received at least one reference signal.

32.-40. (canceled)
